(19) United States
(12) Patent Application Publication
(10) Pub. No.: US 2024/0270399 A1
(43) Pub. Date: Aug. 15, 2024

(54) HYBRID CONTROL SYSTEM SPANNING MULTIPLE OPERATION MODES

(71) Applicant: VerdeGo Aero, Inc., Daytona Beach, FL (US)

(72) Inventors: Patrick Currier, Port Orange, FL (US); David N. Spitzer, Port Orange, FL (US); Xavier Gerardo Santacruz, Port Orange, FL (US); Garrett Wilson, Port Orange, FL (US); Richard Pat Anderson, De Leon Springs, FL (US)

(21) Appl. No.: 18/580,857

(22) PCT Filed: Nov. 17, 2022
(86) PCT No.: PCT/US22/50229

§ 371 Date: Jan. 19, 2024

Related U.S. Application Data
(60) Provisional application No. 63/280,589, filed on Nov. 17, 2021.
(60) Provisional application No. 63/280,560, filed on Nov. 17, 2021.

(51) Int. Cl. B64D 31/18; B64D 27/33; B64D 31/04

(52) U.S. Cl. CPC B64D 31/18; B64D 27/33; B64D 31/04

(57) ABSTRACT

A lever for adjusting output of a hybrid-electric powerplant of an aircraft includes a lever configured to move over an overall range of positions. Movement of the lever adjusts the output of the hybrid-electric powerplant between at least two modes of operation. In a first subset of positions within the overall range of positions, the hybrid electric powerplant is configured to operate an engine having a mechanical output, output first electrical energy from a motor/generator driven by the mechanical output of the engine, and drive a propulsion mechanism by the mechanical output of the engine. In a second subset of positions within the overall range of positions, the hybrid electric powerplant is configured to operate the engine having the mechanical output, receive second electrical energy at the motor/generator, drive the mechanical output with the motor/generator using the second electrical energy, and drive the propulsion mechanism by the mechanical output.

### CROSS-REFERENCE TO RELATED PATENT APPLICATIONS

This application is a 371 National Stage application of International PCT Application No. PCT/US2022/050229, filed Nov. 17, 2022, which claims the benefit of each of U.S. Provisional Patent Application Nos. 63/280,589 and 63/280,560, each filed Nov. 17, 2021, the entire contents of each of which are hereby incorporated by reference in their entirety.

### BACKGROUND

There are varying types of aircraft that are propelled using different types of propulsion mechanisms, such as propellers, turbine or jet engines, rockets, or ramjets. Different types of propulsion mechanisms may be powered in different ways. For example, some propulsion mechanisms like a propeller may be powered by an internal combustion engine or an electric motor. As such, the combination of propulsion mechanisms and methods for providing power to those propulsion mechanisms are often designed specifically for particular aircraft, so that the propulsion mechanisms and methods for providing power to those propulsion mechanisms meet the specifications required to properly and safely propel an aircraft.

### SUMMARY

In an embodiment, a control system for adjusting output of a hybrid-electric powerplant of an aircraft includes an input of a controller configured to receive commands. The controller is configured to set the mode of operation of a hybrid system based on the commands. The mode of operation comprises an output mode of the hybrid-electric powerplant. There are at least two modes of operation. A first command provided to the input causes the hybrid electric powerplant to be configured to operate an engine having a mechanical output, output first electrical energy from a motor/generator driven by the mechanical output of the engine, and drive a propulsion mechanism by the mechanical output of the engine. Upon receiving a second command, the hybrid electric powerplant is configured to operate the engine having the mechanical output, receive second electrical energy at the motor/generator, drive the mechanical output with the motor/generator using the second electrical energy, and drive the propulsion mechanism by the mechanical output.

In an embodiment, a lever for adjusting output of a hybrid-electric powerplant of an aircraft includes a lever configured to move over an overall range of positions. Movement of the lever adjusts the output of the hybrid-electric powerplant between at least two modes of operation. In a first subset of positions within the overall range of positions, the hybrid electric powerplant is configured to operate an engine having a mechanical output, output first electrical energy from a motor/generator driven by the mechanical output of the engine, and drive a propulsion mechanism by the mechanical output of the engine. In a second subset of positions within the overall range of positions, the hybrid electric powerplant is configured to operate the engine having the mechanical output, receive second electrical energy at the motor/generator, drive the mechanical output with the motor/generator using the second electrical energy, and drive the propulsion mechanism by the mechanical output.

In an embodiment, a thrust control system for adjusting output of a hybrid-electric powerplant of an aircraft includes an input of a controller configured to receive commands. The controller is configured to set the mode of operation of a hybrid system based on the commands. The mode of operation comprises an output mode of the hybrid-electric powerplant. There are at least two modes of operation. Upon receipt of a first command at the input, the hybrid electric powerplant is configured to operate an engine having a mechanical output and output first electrical energy from a motor/generator driven by the mechanical output of the engine, the first electrical energy being output to an electric propulsion motor of the aircraft and a battery of the aircraft. Upon receipt of a second command at the input, the hybrid electric powerplant is configured to output second electrical energy from the motor/generator, the second electrical energy being output to the electric propulsion motor of the aircraft and not the battery of the aircraft

### BRIEF DESCRIPTION OF THE DRAWINGS

FIG. 1A illustrates an example flexible architecture for an aerospace hybrid system in accordance with an illustrative embodiment.

FIG. 1B illustrates an additional example flexible architecture for an aerospace hybrid system in accordance with an illustrative embodiment.

FIG. 2A illustrates a block diagram representative of a first aircraft control system for use with a flexible architecture for an aerospace hybrid system in accordance with an illustrative embodiment.

FIG. 2B illustrates a block diagram representative of a second aircraft control system for use with a flexible architecture for an aerospace hybrid system in accordance with an illustrative embodiment.

FIG. 3 illustrates a first example aircraft with which a flexible architecture for an aerospace hybrid system may be used in accordance with an illustrative embodiment.

FIG. 4 illustrates a second example aircraft with which a flexible architecture for an aerospace hybrid system may be used in accordance with an illustrative embodiment.

FIG. 5 illustrates a third example aircraft with which a flexible architecture for an aerospace hybrid system may be used in accordance with an illustrative embodiment.

FIG. 6 is a flow chart illustrating a first example method for using a flexible architecture for an aerospace hybrid system in different flight phases of an aircraft with a main pusher propeller in accordance with an illustrative embodiment.

FIG. 7 is a flow chart illustrating a second example method for using a flexible architecture for an aerospace hybrid system in different flight phases of an aircraft with a main pusher propeller in accordance with an illustrative embodiment.

FIG. 8 illustrates an example flexible architecture for an aerospace hybrid system having a flywheel in accordance with an illustrative embodiment.

FIG. 9 illustrates a perspective view of an example flexible architecture for an aerospace hybrid system in accordance with an illustrative embodiment.

FIG. 10 illustrates a top view of the example flexible architecture of FIG. 9 in accordance with an illustrative embodiment.

FIG. 11 illustrates a side view of the example flexible architecture of FIG. 9 in accordance with an illustrative embodiment.

FIG. 12 illustrates a perspective view of another example flexible architecture for an aerospace hybrid system in accordance with an illustrative embodiment.

FIG. 13 illustrates example downstream and upstream components for propelling an aircraft in accordance with an illustrative embodiment.

FIG. 14 is a diagrammatic view of an example system for providing a direct current (DC) bus with a stable voltage, in accordance with an illustrative embodiment.

FIG. 15 is a flow chart illustrating an example method for maintaining a stable DC bus voltage based on communications from an aircraft-level controller, in accordance with an illustrative embodiment.

FIG. 16 is a flow chart illustrating an example method for maintaining a stable DC bus voltage based on measurements by a hybrid-electric genset-level controller, in accordance with an illustrative embodiment.

FIG. 17 illustrates an example hybrid control system spanning multiple operation modes in accordance with an illustrative embodiment.

FIG. 18 illustrates example operation modes in which an example hybrid architecture may be controlled in accordance with an illustrative embodiment.

FIG. 19 is a diagrammatic view of an example of a computing environment, in accordance with an illustrative embodiment.

### DETAILED DESCRIPTION

Described herein are various embodiments for a thrust control spanning multiple operation modes of a hybrid-electric genset. Various types of modes of operation for a hybrid-electric genset are described herein, such as in the section below titled Hybrid-Electric Gensets and Modes of Operation Thereof. While the various modes of flight may be advantageous to use for an aircraft, they may be complex for a human or computer/controller to operate. For example, a hybrid powerplant system may include multiple modes such as a parallel hybrid mode with a direct output shaft combined with an electrical generator output, it may be difficult or impossible for a pilot or any on-board operator to efficiently use all modes and switch between modes. In other words, the mental overhead may be too great to think about power level for a pilot or other operator, as a pilot or other operator (including, e.g., a computerized or automatic operator) may rather focus on the thrust required to meet a mission or certain phase of a mission. Stated another way, either an automated system or a human pilot/operator may prefer to provide specific instructions for overall thrust rather than provide instructions or make inputs specify transitions between a plurality of modes of operation.

Accordingly, described herein is a one-lever thrust lever design that may span at least two modes of operation of the hybrid powerplant. For example, in a first (low) range of movement, movement of the single lever may cause a blend of thrust output, where the blend includes (1) a range of mechanical shaft power from an engine ranging between low or 0 output and most/all output depending on the position of the lever within the first (low) range of movement; and (2) electrical power being output by a motor/generator to an electrical bus, where the generator is driven by the mechanical shaft power so the electrical power generated ranges from a high or maximum output (e.g., where all of the mechanical shaft power is converted to electrical energy) to a low or 0 output of electricity as the lever approaches a top end of the first (low) range of movement (e.g., less or zero power generated and supplied on the electrical bus).

When the lever moves from the first (low) range of movement the lever may move to a second (high) range of movement. At this point, the electrical generator may cease using part of the mechanical shaft power to generate electric power, and may instead receive electrical power (e.g., from a battery) to further drive the mechanical shaft (e.g., to increase power to mechanical shaft to greater than what the engine could accomplish on its own). In other words, from this point, as the lever moves further the thrust level may automatically engage the motor/generator into motor mode, pulling power from a DC bus and adding to the shaft thrust supplied to a propeller, fan, or gearbox. In such an embodiment, in the second (high) range, the engine power may be at a constant high or maximum level, and the power pulled from the DC bus may range from a zero or low level at the bottom of the second (high) range of the lever to a high or maximum level at the top of the second (high) range of the lever.

Although a physical lever is described herein, a computerized or automatic controller may also be implemented according to the embodiments herein. For example, a aircraft-wide system controller may request certain levels of thrust similar to how a physical thrust lever may be moved to request certain levels of thrust. A hybrid-electric powerplant as described herein may have its own controller that may respond to such requests in the same way it may respond to a physical lever. In other words, the aircraft-wide system controller may not request or supply information related to specific power generation modes, but may instead request a level of desired thrust and the hybrid-electric powerplants described herein may react accordingly to provide different levels of thrust across multiple modes of operation without requiring a request for a specific mode of operation.

Advantageously, such embodiments provide for a simplified operation of a hybrid-electric powerplant that may offer maximum flexibility and options to deliver performance in flight. Reduces pilot training and chances for pilot error. This one-lever system may also advantageously make possible a simplified overall supervisory controller for a hybrid-electric powerplant, where such a controller uses deterministic coding techniques and offers a faster and less burdensome path to Federal Aviation Administration (FAA) certification.

### Hybrid-Electric Gensets and Modes of Operation Thereof

Aircraft typically have custom designed propulsion mechanisms and methods for powering those propulsion mechanisms. In this way, the propulsion mechanisms and power supplied to those propulsion mechanisms can be optimized to provide the amount of propulsion needed for a particular type and size of aircraft, while minimizing weight of the components in the aircraft. In other words, the propulsion mechanisms and power for those propulsion mechanisms are often optimized for a particular type and size of aircrafts such that components of one aircraft could not be easily used in a different types of aircraft drive architectures, such as direct drive aircraft, parallel drive aircraft, and serial drive aircraft.

Described herein are various embodiments for a flexible architecture for an aerospace hybrid system and optimized components thereof. A hybrid system may be or may include a system where fuel is burned in a piston, rotary, turbine, or other engine, and an output of the piston engine may be operatively connected to an electric generator for outputting electric power. The embodiments described herein may include flexible systems that can provide power for many different types of aircraft and propulsion mechanisms. Such systems may advantageously reduce the complexity of designing different types of aircraft, may reduce the costs of manufacturing such systems as less customization allows for economies of scale in mass producing the systems, and ultimately may reduce the complexity of aircraft that use the systems described herein.

The flexible architectures described herein may further be used to provide power to propulsion mechanisms in different ways, either in a same aircraft or in different aircraft. For example, a flexible architecture for providing power to propulsion mechanisms may be able to operate in multiple different modes to provide power to different types of propulsion mechanisms. A first aircraft may utilize one, some, or all of the multiple different modes in which the flexible architecture may operate. A second aircraft may utilize one, some, or all of the multiple different modes, and the modes utilized by the second aircraft may be different than those utilized by the first aircraft.

Therefore, different aircraft may take advantage of different modes of providing power to propulsion mechanisms provided by the flexible architectures described herein. While use of the flexible architectures may be customized in this way, the physical hardware of the flexible architectures may be adapted to use by different aircraft with minimal or no changes to the physical components of the flexible architectures described herein. Instead, the use of different modes in different aircraft may be accomplished largely based on how the components of the flexible architectures are controlled using a processor or controller. As such, computer readable instructions may therefore also be stored on a memory operably coupled to a processor or controller, such that when the instructions are executed by the processor or controller, a computing device that includes the processor or controller may control the various components of the flexible architectures described herein to utilize any possible mode of use desired for a particular implementation, aircraft, flight phase, etc.

Power generation and propulsion systems for aircraft may also utilize various cooling systems to ensure that the various components of an aircraft remain at safe temperatures for operation, as well as maintaining components within temperature ranges where they may operate more efficiently. Further described herein are advantageous cooling systems that leverage various aspects of the hybrid architecture described herein to efficiently cool components of a flexible architecture for providing power to propulsion mechanisms of an aircraft.

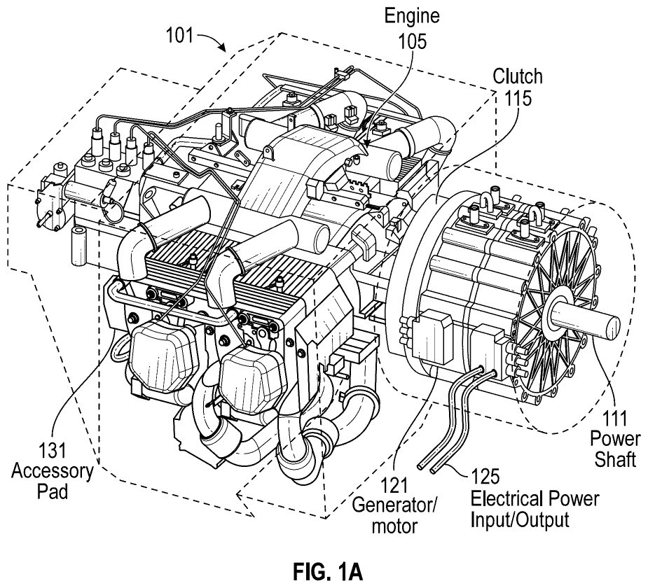

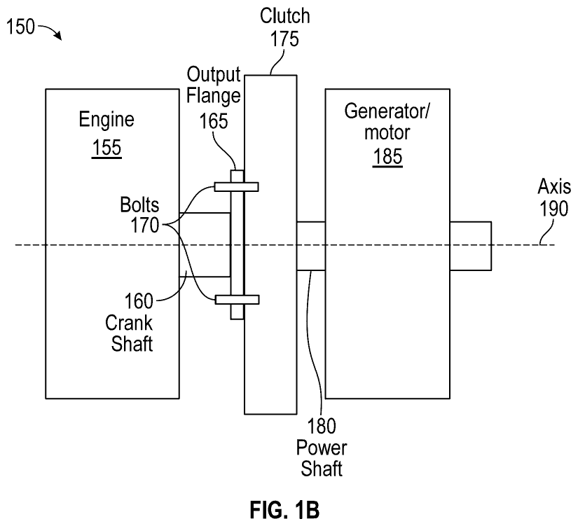

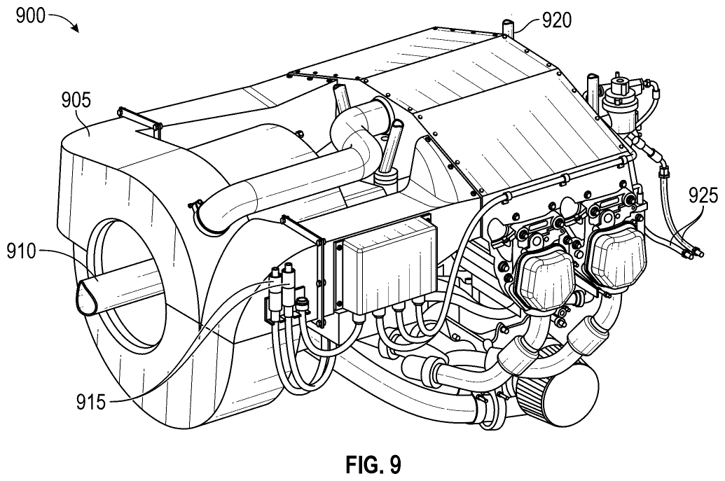

Aircraft that have hardware for providing different modes of power to its propulsion mechanisms, may have a variety of components for which it may be desirable to provide cooling. Thus, a single cooling system that efficiently moves air to the different components that enable different modes of power may cut down on weight of the aircraft, as well as power consumption of the cooling systems. FIGS. 1-8 and their accompanying description below specifically relate to example flexible architectures for providing power to propulsion systems of an aircraft, and FIGS. 9-21 and their accompanying description below relate to various embodiments of cooling systems for the example flexible architectures.

FIG. 1A illustrates an example flexible architecture 101 for an aerospace hybrid system in accordance with an illustrative embodiment. As discussed herein, the flexible architecture 101 may be efficiently used in a wide array of applications with a single hybrid generator system that can be applied in multiple ways depending on the aircraft requirements and phase of flight (e.g., used in different modes).

The flexible architecture 101 of FIG. 1A is a hybrid generator that includes an engine 105, a clutch 115, a generator/motor 121, and a power shaft 111. As described further below, the flexible architecture 101 may be used to implement various different modes depending on requirements of a specific aircraft installation or a specific phase of flight as desired. The engine 105 may be a combustion engine, such as an internal combustion engine. The engine 105 may further specifically be one of a piston internal combustion engine, a rotary engine, or a turbine engine. Such engines may use standard gasoline, jet fuel (e.g., Jet A, Jet A-1, Jet B fuels), diesel fuel, biofuel substitutes, etc. . . . In various embodiments, other types of engines may also be used, such as a smaller engine for drone implementations (e.g., a Rotax gasoline engine).

As described above, the engine 105 may be a piston combustion engine. A piston combustion engine may advantageously spin an output rotor or shaft at rotations per minute (RPMs) that may be more desirable for direct output to power a generator and/or a propulsion mechanisms (e.g., a propeller) than other engines. For example, a piston combustion engine may have an output on the order of thousands of RPMs. For example, a piston combustion engine may have an output anywhere from 2200 to 2500 RPM, which may be a desirable RPM for a propeller. In particular, a propeller may be designed to have a size that yields a desired tip speed of the propeller based on the RPM output of the piston combustion engine (e.g., of 2200 to 2500 RPM). Other types of engines, such as a turbine engine, may output rotational power on the order of tens of thousands of RPMs, much higher than a piston combustion engine. Another embodiment may drive the motor/generator at the higher RPM of a turbine engine to benefit the efficiency, power output, or other important factors. In some embodiments, a gear box could be added between the output of a high RPM engine and the other components of FIG. 1A to step down the output RPM of the engine 105. However, the addition of a gear box may also add weight to the system that is undesirable in some embodiments. A piston combustion engine may further be advantageous with respect to noise as compared to turbine engines. Turbine engines typically are louder than piston combustion engines, and the noise perceived by humans from a turbine engine is typically more offensive to a listener than the noise produced by a piston combustion engine. Quieter engines may also be more valuable in urban or more dense settings where reduced noise is desirable.

The engine 105 may output rotational power to the clutch 115, which may be controlled to engage or disengage the power shaft 111. In other words, the power shaft 111 may be engaged with the rotational output of the engine 105 by the clutch 115, so that rotational force may be transferred between the engine 105 output and the power shaft 111. When the clutch 115 disengages the output of the engine 105 and the power shaft 111, the power shaft 111 may rotate independently of the output of the engine 105. The clutch 115 may be physically located between the engine 105 and the generator/motor 121, and may even contact the engine 105 and the generator/motor 121 on opposing sides in order to reduce the overall footprint of the flexible architecture.

The generator/motor 121 may also be engaged or disengaged with the power shaft 111. In other words, the generator/motor 121 may be controlled to switch off such that rotation of the power shaft 111 does not cause the generator/motor 121 to generate electrical power. Similarly, the generator/motor 121 may also be controlled to switch on such that the rotation of the power shaft causes the generator/motor 121 to generate electrical power. The generator/motor 121 is referred to as a generator/motor because it may function as either a generator or a motor. In various embodiments, the generator/motor 121 may be referred to as an electric machine, where an electric machine may be an electric generator, an electric motor, or both.

The flexible architecture further includes an electrical power input and output (I/O) 125 connected to the generator/motor 121. As described further herein, the generator/motor 121 may generate electrical power based on rotation of the power shaft 111 that is output via the electrical power I/O 125 or may receive electrical power via the electrical power I/O 125 that may be used to drive the power shaft 111.

The generator/motor 121 may also act as a driver for the power shaft 111. Upon receiving electrical power via the electrical power I/O 125 from batteries or some other form of electrical energy storage elsewhere in the system, the generator/motor 121 may impart a rotational force on the power shaft 111 to drive the power shaft 111. This may occur as long as the generator/motor 121 is controlled to be switched on to engage with the power shaft 111. If the generator/motor 121 is controlled to be switched off such that it does not engage with the power shaft 111, the power shaft 111 may not be rotated by the generator/motor 121.

Electrical power output from the electrical power I/O 125 may be used to drive an electric motor for an electric propulsion mechanism (e.g., a propeller). Electrical power output from the electrical power I/O 125 may also be used to power and/or charge other devices on an aircraft or aerospace vehicle. For example, electrical power output from the electrical power I/O 125 may be used to charge one or more batteries. The electrical power output from the electrical power I/O 125 may also be used to power other devices or accessories on an aircraft or aerospace vehicle. Because the electrical power I/O 125 also has an input, the power shaft 111 may be driven by any electrical power received via the electrical power I/O 125, such as power from one or more batteries. The power generated by the generator/motor 121 may be an alternating current (AC) power. That AC power may be converted by power electronics (e.g., a rectifier or inverter) into direct current (DC) power and output to a DC bus. That DC bus may be connected to batteries and/or an electric propulsion mechanism. In this way, the electric propulsion mechanism may be supplied with power via a DC bus. In various embodiments, a motor of the electric propulsion mechanism may use AC power, and the DC power from the DC bus may therefore be converted from DC power to AC power before it is used by the electric propulsion mechanism (e.g., by an inverter).

Any rotation of the power shaft 111 itself, whether driven by the engine 105 or the generator/motor 121, may also be used to drive one or more propulsion mechanisms. For example, rotation of the power shaft 111 may be used to direct drive a propeller or may be used to power an electric motor that drives a propulsion mechanism. The rotation of the power shaft 111 may also drive a gearbox operably connected to another component, such as one or more propellers, one or more rotors, or other rotating devices for various uses on an aircraft.

An accessory pad 131 may also be coupled to the engine 105, and may include a lower voltage direct current (DC) generator for electrical power that is separate from the generator/motor 121 and the electrical power I/O 125, which may be configured for high voltage and high power I/O. In some embodiments, the generator/motor 121 may also have two different windings and the electrical power I/O 125 may have two different outputs (e.g., high voltage and low voltage). Accessory power may be associated with one of the electrical power I/O 125 outputs in addition to or instead of the accessory pad 131 output. The accessory pad 131 may be used to provide power to devices or accessories on an aircraft or aerospace vehicle that does not require high voltage or current outputs that may be output by the generator/motor 121 at the electrical power I/O 125. A high voltage (HV) of an aircraft may be, for example, 400 volts (V) or 800 V, but may also be anywhere between 50 V to 1200 V. A low voltage (LV) of an aircraft may be 12 V, 14 V, 28 V, or any other voltage below 50 V.

FIG. 1B illustrates an additional example flexible architecture 150 for an aerospace hybrid system in accordance with an illustrative embodiment. In particular, the flexible architecture 150 of FIG. 1B includes some components that may be the same as or similar to the components described above with respect to FIG. 1A, including an engine 155, a clutch 175, a power shaft 180, and/or a generator/motor 185. The flexible architecture 150 further illustrates the output of the engine 155 in the form of a crankshaft 160, which is rigidly connected to an output flange 165. The output flange 165 is rigidly connected to one side of the clutch 175 with bolts 170.

The clutch 175 may be configured to engage the power shaft 180 to translate rotational motion from the crankshaft 160 and the output flange 165 to the power shaft 180. The clutch 175 may be further configured to disengage the power shaft 180 such that the power shaft 180 may rotate independently with respect the crankshaft 160 and the output flange 165. In addition, FIG. 1B demonstrates how the rotatable components of the flexible architecture 150 may be all be aligned along a single axis 190. The rotatable components of FIG. 1A may similarly be aligned along a single axis as shown in FIG. 1B. In addition, the power shaft 180 may be a splined shaft that fits into an inner diameter opening of the clutch 175 and the generator/motor 185. Other features than a spline may also be used, such as a taper. In any case, the generator/motor 185 and/or the clutch 175 may be configured to accommodate and connect to a spline, taper, or other feature on the power shaft 180 so that the components may properly engage with one another.

Advantageously, the generator/motor 121 of FIG. 1B and/or the generator/motor 185 may be used as a starter for the engine 105 or the engine 155, respectively. In other words, the generator/motor 185 may be used to turn the crankshaft 160 while the clutch 175 is engaged in order to start up the engine 155. Such a system may be advantageous where, for example the generator/motor 185 may be powered by a battery or other electrical power source. The engine 155, which may be a piston combustion engine as described herein, therefore may not require separate starter components, reducing the weight and complexity of the flexible architectures described herein.

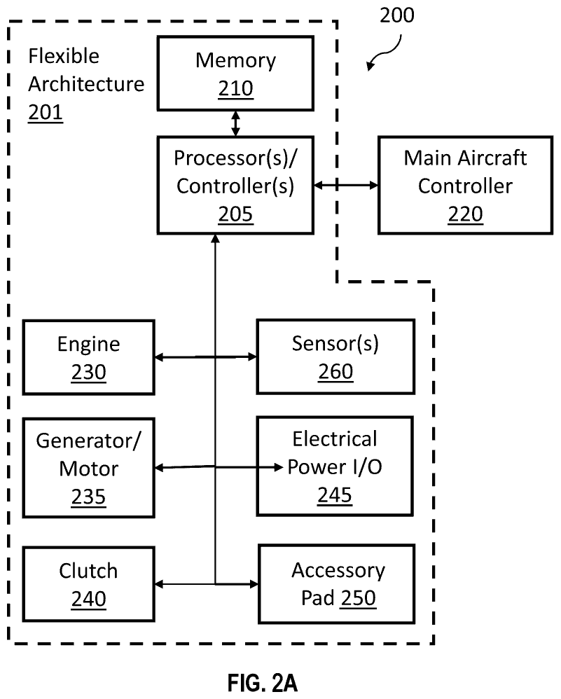

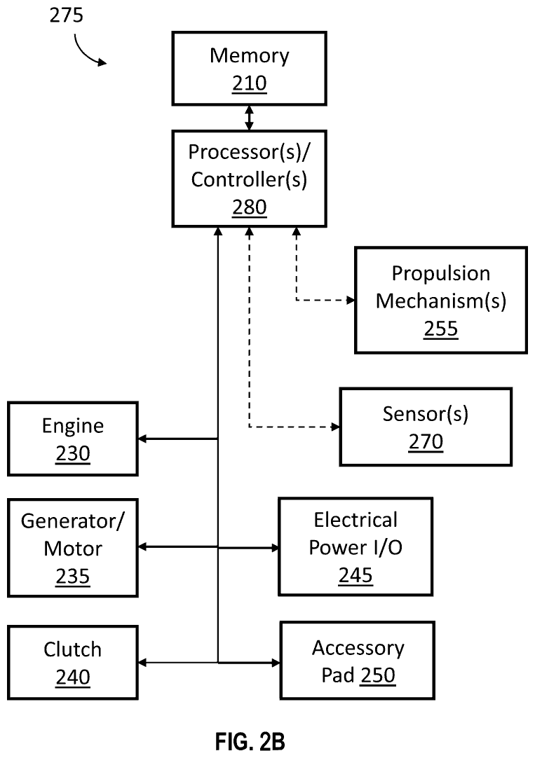

FIG. 2A illustrates a block diagram representative of an aircraft control system 200 for use with a flexible architecture 201 for an aerospace hybrid system in accordance with an illustrative embodiment. The aircraft control system 200 may be used, for example, to implement one or more of the various modes discussed below in which the flexible architectures described herein may be used. The flexible architecture 201 may be the same as, similar as, or may have some or all of the components of the flexible architectures 101 and/or 150 of FIGS. 1A and/or 1B. The aircraft control system 200 may include one or more processors or controllers 205 (hereinafter referred to as the controller 205), memory 210, a main aircraft controller 220, an engine 230, a generator/motor 235, a clutch 240, an electrical power I/O 245, an accessory pad 250, and one or more sensor(s) 260. The connections in FIG. 2A indicate control signal related connections between components of the aircraft control system 200. Other connections not shown in FIG. 2A may exist between different aspects of the aircraft and/or aircraft control system 200 for providing electrical power, such as a high voltage (HV) or low voltage (LV) power for an aircraft.

The memory 210 may be a computer readable media configured for instructions to be stored thereon. Such instructions may be computer executable code that is executed by the controller 205 to implement the various methods and systems described herein, including the various modes of using the flexible architectures herein and combinations of those modes. The computer code may be written such that the various methods of implementing different modes of the flexible architectures herein are automatically implemented based on various inputs that indicate, for example, a particular flight phase (e.g., landing, takeoff, cruising, etc.). In various embodiments the computer code may be written to implement the various modes herein based on input from a user or pilot of the aircraft or aerospace vehicle, or may be implemented based on a combination of user input and automatic implementation based on non-human inputs (e.g., from sensors on or off the aircraft, based on planned flight plans, etc.) The controller 205 may be powered by a power source on the aircraft or aerospace vehicle, such as the accessory pad 131, one or more batteries, an output of the electrical power I/O 125, a power bus of the aircraft powered by any power source, and/or any other power source available.

The controller 205 may also be in communication with each of the engine 230, the generator/motor 235, the clutch 240, the electrical power I/O 245, the accessory pad 250, and/or the sensor(s) 260. In this way, the components of flexible architectures may be controlled to implement various modes as described herein. In various embodiments, engine 230, the generator/motor 235, the clutch 240, the electrical power I/O 245, and the accessory pad 250 may be similar to or may be the similarly named components shown in and described above with respect to FIG. 1A. The electrical power I/O 245 may also include pre-charge electronic components, for example, for protecting the electrical components of the flexible architectures, including a direct current (DC) bus, as described herein from excessive in rush current on startup. For example, if a high-voltage (HV) bus is at 400V and a new component is connected to the HV bus at 0 v, the instantaneous current rush may be extremely high and may be damaging to the HV bus and/or the component. As a result, the pre-charge electronic components may provide for slowly bringing up a component voltage before making a full connection to the HV bus or other power supply.

The sensor(s) 260 may include various sensors for monitoring the different components of the flexible architecture 201. Such sensors may include temperature sensors, tachometers, fluid pressure sensors, voltage sensors, current sensors, state sensors to determine, for example, a current state of the clutch 250, or any other type of sensor. For example, voltage and/or current sensors may be used to inform function and settings of a motor/generator, a state chosen for the clutch, or for adjusting any other component of a system. A state sensor could also indicate a specific mode the flexible architecture is being used in, and the system may receive inputs (e.g., from a pilot, from an automated flight controller), to change the system to a different state or mode for a certain phase of flight that may be upcoming. Other sensors may include a pitot tube for measuring aircraft airspeed, an altimeter for measuring aircraft altitude, and/or a global positioning system (GPS) or similar geographic location sensor for determining a location relative to the ground and/or known/mapped structures.

The components of FIG. 2A inside the flexible architecture 201 dashed line may be associated with the flexible architecture as described herein, while the main aircraft controller 220 may be associated with the broader aircraft systems. In other words, the main aircraft controller 220 may control aspects of the aircraft other than the flexible architecture 201, while the controller 205 controls aspects of the aircraft related to the flexible architecture 201. The main aircraft controller 220 and the controller 205 may communicate with one another to coordinate providing power to the various propulsion mechanisms of the aircraft. For example, the main aircraft controller 220 may transmit signals to the controller 205 requesting particular power output levels for one or more particular propulsion mechanisms. The controller 205 may receive such control signals and determine how to adjust the flexible architecture 201 (e.g., what modes to enter and how to control the elements of the flexible architecture 201) to output the desired power levels based on the control signals from the main aircraft controller 220. In various embodiments, the main aircraft controller 220 may transmit signals that are related to controlling specific aspects of the flexible architecture 201. In other words, the controller 205 may act as a relay to retransmit control signals from the main aircraft controller 220 to the components of the flexible architecture 201, in addition to or instead of transmitting desired power output signals to the controller 205 from which the controller 205 determines how to control the individual components of the flexible architecture 201.

In various embodiments, the main aircraft controller 220 may also transmit control signals related to future desired power outputs, future flight phase or flight plan information, etc. In this way, the controller 205 may receive and use information about the expected power demands of the aircraft to determine how to control the aspects of the flexible architecture 201 at both a present moment and in the future. For example, flight plan information may be used to determine when battery power should be used, when batteries should be charged, etc. In another example, if a big demand for power is expected, the controller 205 may ensure that the engine 230 is running at a desired RPM to begin delivering a desired level of power.

In various embodiments, the controller 205 may also be in communication with one or more batteries to monitor their charge levels, control when the batteries are charged or discharged, control when the batteries are used to power the generator/motor 235, control when the batteries are used to directly power another aspect of the aircraft. However, in other embodiments, the main aircraft controller 220 may be in communication with batteries of the aircraft, and/or may relay information related to the batteries and control thereof to the controller 205. Similarly, if the batteries of the aircraft are controlled with the main aircraft controller 220 rather than the controller 205, the controller 205 may transmit control signals related to the batteries to the main aircraft controller so that the batteries may be controlled as needed or desired with respect to the functioning of the flexible architecture 201.

In various embodiments, the electrical power I/O 245 may include two different outputs (e.g., a high voltage (HV) output and low voltage (LV) output) that are associated with two different windings of the generator/motor 235. As such, two different voltages (e.g., HV and LV) may be output and controlled by the controller 205 and/or the main aircraft controller 220. The electrical power I/O 245 may additionally or alternatively have voltage conversion components (e.g., a DC to DC converter) such that two or more different voltages may be output. In such an embodiment, two different outputs may be achieved without the use of two separate windings. The two different outputs may, for example, be output to different power busses on the aircraft, such as a HV bus and a LV bus. The two outputs of the electrical power I/O 245 may also be separately controlled by the controller 205. As such, the outputs may be turned off (e.g., by letting the power shaft and rotor of the generator spin or freewheel with respect to the rest of the motor/generator by turning off field current of the motor/generator).

In some embodiments, the accessory pad may not be controlled by the controller 205 and/or the main aircraft controller 220. The accessory pad may simply always be on when the engine 230 is operating, or may be controlled separately (e.g., by a manual switch flipped by a user) to control when and how power is supplied to accessories on the aircraft.

In some embodiments, the controller 205 may be in communication with a wireless transceiver that may be on-board an aircraft or aerospace vehicle, so that the controller 205 may communicate with other computing devices not hard-wire connected to the system 200. In this way, instructions or inputs for implementing the various modes for the flexible architectures described herein may also be received from a remote device computing device wirelessly. In other embodiments, the system 200 may only communicate with components on-board the aircraft.

FIG. 2B illustrates a block diagram representative of a second aircraft control system 275 for use with a flexible architecture for an aerospace hybrid system in accordance with an illustrative embodiment. In the example of FIG. 2B, the system 275 does not have a separate main aircraft controller as in FIG. 2A. Instead, the entire aircraft has a single main controller 280 that controls all aspects of the flexible architecture and the aircraft (including, e.g., propulsion mechanisms 255 of the aircraft).

The controller 285 may be in communication with one or more of the propulsion mechanism(s) 255 on the aircraft to control them. The controller 285 may also be in communication with one or more sensor(s) 270 on an aircraft or aerospace vehicle, which may be sensors of the aircraft and sensors of the flexible architecture. In particular, the sensor(s) 260 may also be embedded in any of the components of FIGS. 1A and/or 1B described above, and therefore may be used to inform how the devices of FIGS. 1A and/or 1B are controlled and/or how the modes described herein are implemented as described herein.

In either of FIG. 2A or 2B, the controller 205, the controller 285, and/or the main aircraft controller 220 may also be in communication with a cooling system configured to cool and/or heat any components of the flexible architecture, one or more batteries, or any other aspect of an aircraft. As such, a cooling system may also be controlled in concert with the other systems and methods described herein.

Described below are five specific modes that may be implemented using various embodiments of the flexible architecture described herein (including, e.g., the flexible architectures shown in and described with respect to FIGS. 1A, 1B, 2A, and 2B).

In a first mode, which may be referred to herein as a hybrid generator mode, a clutch (e.g., the clutch 115 of FIG. 1A and/or the clutch 175 of FIG. 1B) may be controlled to engage an engine (e.g., the engine 105 of FIG. 1A and/or the engine 155 of FIG. 1B) to a power shaft (e.g., the power shaft 111 of FIG. 1A and/or the clutch output/power shaft 180) that runs between the clutch to a generator/motor (e.g., the generator/motor 121 of FIG. 1A and/or the generator motor 185 of FIG. 1B) such that the engine spins the power shaft within the generator/motor to generate electrical power to be supplied via an electrical power I/O (e.g., the electrical power I/O 125 of FIG. 1A) to other systems on an aircraft such as propulsion mechanisms/systems. For example, such propulsion mechanisms/systems may be powered using electric motors, and the electrical power output by the generator/motor in the first mode may be used to drive such propulsion mechanisms/systems. In short, in the first mode, the engine may be engaged with the power shaft using the clutch to drive the generator/motor and output electrical power from the generator/motor.

In a second mode, which may be referred to herein as a direct drive engine mode, a clutch (e.g., the clutch 115 of FIG. 1 and/or the clutch 175 of FIG. 1B) may engage an engine (e.g., the engine 105 of FIG. 1A and/or the engine 155 of FIG. 1B) output to a power shaft (e.g., the power shaft 111 of FIG. 1A and/or the clutch output/power shaft 180) that runs through a generator/motor (e.g., the generator/motor 121 of FIG. 1A and/or the generator motor 185 of FIG. 1B) to provide mechanical power to a propulsion mechanism like a propeller on an aircraft. In such a mode, the field may be removed from the generator/motor (e.g., the generator/motor may be controlled to be off or disengaged) such that a power shaft and rotor of the generator/motor is spinning or freewheeling and an electrical power I/O (e.g., the electrical power I/O 125 of FIG. 1A) of the generator/motor is therefore disengaged and not outputting electrical power. In short, in the second mode, the engine may drive a power shaft to mechanically or otherwise power a propulsion mechanism, while the power shaft spins within the generator/motor without receiving or outputting electrical power at the electrical power I/O.

In a third mode, which may be referred to herein as an augmented thrust mode, a clutch (e.g., the clutch 115 of FIG. 1 and/or the clutch 175 of FIG. 1B) may engage an engine (e.g., the engine 105 of FIG. 1A and/or the engine 155 of FIG. 1B) to a power shaft (e.g., the power shaft 111 of FIG. 1A and/or the clutch output/power shaft 180) that runs through a generator/motor (e.g., the generator/motor 121 of FIG. 1A and/or the generator motor 185 of FIG. 1B) and the generator/motor is used as a motor to pull power in through an electrical power I/O (e.g., the electrical power I/O 125 of FIG. 1A) from an external source such as a battery pack. This provides a higher mechanical power output on the power shaft than either the engine or the generator/motor may be capable of delivering. In short, in the third mode, both the engine and the generator/motor are used to drive the power shaft simultaneously to send power to a propulsion mechanism.

In a fourth mode, which may be referred to herein as a direct drive generator/motor mode, a clutch (e.g., the clutch 115 of FIG. 1 and/or the clutch 175 of FIG. 1B) may disengage an engine (e.g., the engine 105 of FIG. 1A and/or the engine 155 of FIG. 1B) from a generator/motor (e.g., the generator/motor 121 of FIG. 1A and/or the generator motor 185 of FIG. 1B) such that power can be fed to the generator/motor via an electrical power I/O (e.g., the electrical power I/O 125 of FIG. 1A) to drive the generator/motor as a motor and provide mechanical power to a power shaft (e.g., the power shaft 111 of FIG. 1A and/or the clutch output/power shaft 180). In short, in the fourth mode, the generator/motor alone may provide power to a propulsion mechanism based electrical power received at the electrical power I/O.

In a fifth mode, which may be referred to herein as a split engine power mode, a clutch (e.g., the clutch 115 of FIG. 1 and/or the clutch 175 of FIG. 1B) may engage an engine (e.g., the engine 105 of FIG. 1A and/or the engine 155 of FIG. 1B) to a generator/motor (e.g., the generator/motor 121 of FIG. 1A and/or the generator motor 185 of FIG. 1B) such that the engine may cause the generator/motor to spin as a generator and provide both electrical power to other systems on the aircraft via an electrical power I/O (e.g., the electrical power I/O 125 of FIG. 1A) as well as providing mechanical power to a power shaft (e.g., the power shaft 111 of FIG. 1A and/or the clutch output/power shaft 180) to drive systems like a propeller. In short, in the fifth mode, the engine may be used to drive the power shaft and the generator/motor to output power via the electrical power I/O and the power shaft.

As described herein, any of these five modes (or variations thereof) may be used with the single flexible architecture described herein. In addition, certain modes and or combinations of modes may be beneficial for certain aircraft or aerospace vehicle types, certain propulsion mechanism types, certain flight phases of an aircraft or aerospace vehicle, etc.

For example, in a hybrid electric vertical takeoff and landing (VTOL) aircraft with electric motor driven propellers, the flexible architecture herein may be used solely as a source of electrical power. As such, the flexible architecture may drive the aircraft in the first mode (e.g., the hybrid generator mode) during any portion of a phase of flight in which power must be provided to a power bus of the aircraft or one or more motors of the aircraft.

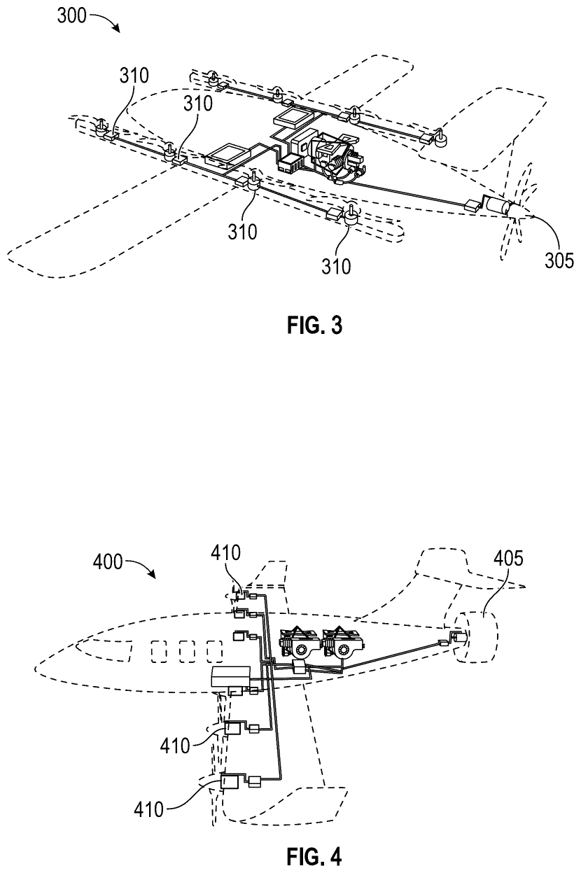

In another example, in an aircraft with a single, large main pusher propeller (e.g., at the rear of a fuselage of an aircraft) and array of electric motors/propellers (e.g., on a wing of an aircraft) the flexible architecture may be used in the fifth mode (e.g., split engine power mode) during takeoff to supply power mechanically to the main pusher propeller and electrically to the wing-mounted motors. FIGS. 3 and 4 illustrate two examples of such an aircraft 300 and 400 with which a flexible architecture for an aerospace hybrid system may be used in accordance with an illustrative embodiment. For example, the aircraft 300 has a main pusher propeller 305, and the aircraft 400 has a main pusher propeller 405 in the form of a ducted pusher fan. In both examples the fifth mode described herein may be used to supply power mechanically to the main pusher propellers 305 and 405 from a power shaft. Additionally, wing mounted electric motors/propellers 310 and 410 may be driven with electrical power from a motor/generator as described herein.

Alternatively, the flexible architecture described herein may be used to power configurations like those shown in FIGS. 3 and 4 in the third mode (e.g., augmented thrust mode) on takeoff by having a battery pack supply power to both the wing-mounted motors and to augment the engine power on the power shaft driving the main pusher propeller. In cruising flight, the aircraft may use the second mode (e.g., the direct drive engine mode) to just drive the main pusher propeller. In another example, during cruising flight, the aircraft may be equipped with a clutch between the power shaft and the pusher propeller, and the controller may cause the aircraft to operate in the first mode (e.g., hybrid generator mode) driving the wing mounted motors by disengaging the power shaft from the pusher propeller and outputting power from the generator/motor to the wing mounted motors. In another example (e.g., an emergency situation such where the engine failure), the pusher prop may be driven in the fourth mode (e.g., the direct drive generator/motor mode) using power input to the electrical power I/O such as from one or more batteries.

In another example, an aircraft may be a VTOL aircraft with a gyrocopter style main rotor that may be operated powered or unpowered, and may have forward propulsion motors and propellers mounted on wings. In an embodiment, the flexible architecture may be used entirely in the first mode (e.g., the hybrid generator mode) with electrical power supplied from the electrical power input/output (and the generator/motor) driving a motor coupled to the gyrocopter style main rotor and driving the wing-mounted motors using electrical power. In an embodiment, the aircraft may also be configured with a clutch between the power shaft and the gyrocopter style main rotor such that the flexible architecture may use the second mode (e.g., the direct drive engine mode) or the third mode (e.g., augmented thrust mode) to spin the gyrocopter style main rotor (e.g., to get the gyrocopter style rotor up to speed for takeoff). In such an example, the controller may then cause the flexible architecture to switch to the first mode (e.g., the hybrid generator mode) after the gyrocopter style rotor is up to speed (e.g., switch to the first mode for cruising flight). The fourth mode (e.g., the direct drive generator/motor mode) may again be used in the event of an engine failure to use electrical power to drive the power shaft (and therefore the gyrocopter style rotor) from a power source such as one or more batteries.

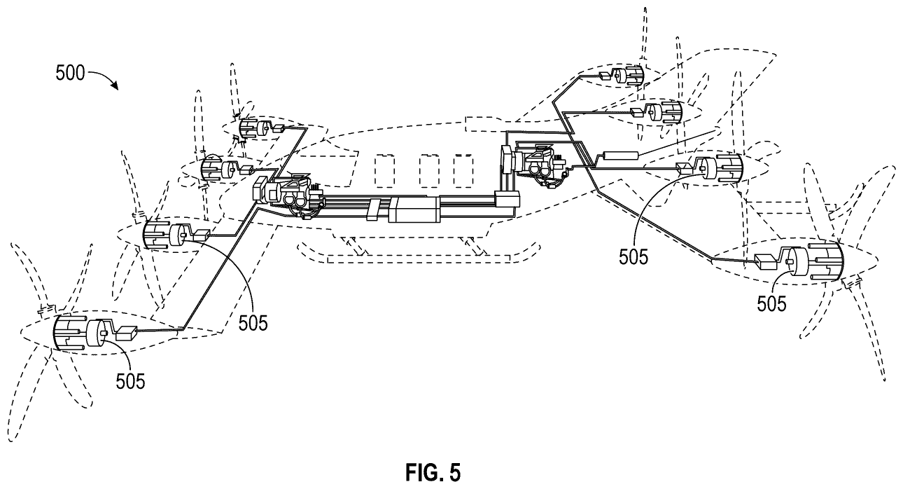

FIG. 5 illustrates another example aircraft 500 with which a flexible architecture for an aerospace hybrid system may be used in accordance with an illustrative embodiment. For example, the aircraft 500 may include multiple (e.g., 8) electric motors/propellers 505 on tilt wings, which may be powered using the first mode described herein (e.g., the hybrid generator mode), where an engine may be engaged with a power shaft using a clutch to drive a generator/motor and output electrical power from the generator/motor to the various electric motors/propellers 505 on the tilt wings.

Accordingly, described herein are advantageous flexible architectures for aircraft through which a variety of modes for supplying power to propulsion mechanisms may be achieved. While particular aircraft and propulsion mechanism configurations may not utilize each mode described herein that a flexible architecture is capable of, the flexible architectures may still be implemented in different aircraft to achieve different modes. Similarly, while an example of a flexible architecture with five different modes for powering propulsion mechanisms is described in detail herein, other flexible architectures with fewer, more, or different modes for powering propulsion mechanisms are also contemplated herein.

For example, a flexible architecture may not have a clutch as described herein and may still be able to implement various modes described herein where it is desirably to have the engine output coupled to the motor/generator and/or an output power shaft of the system. For example, in the first mode, the engine may rotate a power shaft to cause the generator to generate electricity. In the second mode, the engine may direct drive a mechanical propulsion component, for example, but the engine need not be disengaged from the motor/generator or power shaft because the motor/generator can be turned off or allow the power shaft and rotor of the motor/generator to freewheel within the motor/generator. In the third mode, the engine and motor/generator are used to drive the power shaft, so it would not be desirable to disengage the engine and the motor/generator using a clutch. In the fifth mode, the engine may rotate a power shaft to cause the generator to generate electricity and to cause the power shaft to mechanically power a propulsion mechanism. As such, the power shaft need not be disengaged from the engine output in an aircraft that utilizes any of the first, second, third and/or fifth modes as described above. As such, for an implementation that uses any combination of the first, second, third, and/or fifth modes (and not the fourth mode), a clutch may not be used as the system may have the output of the engine constantly connected to the power shaft in the motor/generator. Such an embodiment may be valuable because clutches may be heavy and/or unreliable.

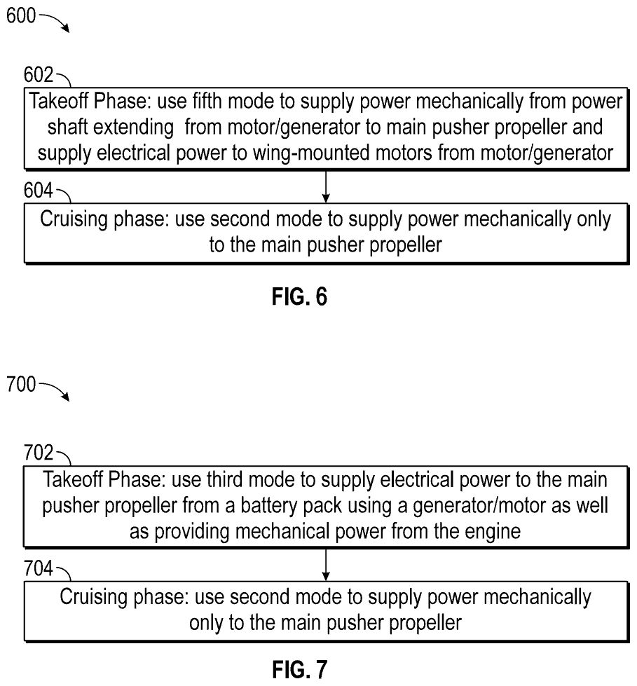

FIG. 6 is a flow chart illustrating a first example method 300 for using a flexible architecture for an aerospace hybrid system in different flight phases of an aircraft with a main pusher propeller in accordance with an illustrative embodiment. In particular, the aircraft may be an aircraft with a single larger pusher propeller and an array of electric motors and corresponding smaller propellers on the wings. During a takeoff flight phase at 602, the fifth mode described herein may be used to supply power mechanically to main pusher propeller and electrical power to wing-mounted motors. During a cruising flight phase at 604, the second mode described herein may be used to supply power mechanically only to the main pusher propeller and not supply power to the smaller electric motors/propellers.

FIG. 7 is a flow chart illustrating a second example method 400 for using a flexible architecture for an aerospace hybrid system in different flight phases of an aircraft with a main pusher propeller in accordance with an illustrative embodiment. In particular, the aircraft may be an aircraft with a single larger pusher propeller and an array of electric motors and corresponding smaller propellers on the wings. During a takeoff flight phase at 702, the third mode described herein called augmented thrust may be used to supply electrical power via a generator/motor to the main pusher propeller (drawing power from batteries) and providing power mechanically directly from the engine to the main pusher propeller. In addition, electrical power (generated by the generator/motor and/or directly from the batteries) may also be provided to the electric motors on the wings during takeoff. During a cruising flight phase at 704, the second mode described herein may be used to supply power mechanically only to the main pusher propeller and not supply power to the smaller electric motors/propellers.

Referring back to FIG. 1A, if the clutch 115 is engaged such that the engine 105 applies power to the power shaft 111 and the generator/motor 121 is not active or on, the power shaft 111 may freewheel within the generator/motor 121 (e.g., the second mode described above). Similarly, the power shaft 180 of FIG. 1B may freewheel within the generator/motor 185 in various embodiments. However, the engine 105 and/or the engine 155 may create torque pulses on the power shaft 111 and/or the power shaft 180 that can be dangerous to a generator, such as the generator/motor 121 and/or the generator/motor 185 when the clutch 115 and/or the clutch 175 is engaged with their respective power shafts 111 and/or 180. In other words, large torque pulses on a shaft similar to those that may occur when certain types of engines fire (e.g., diesel piston combustion engines) may cause high angular accelerations that may cause fatigue or damage to components of the generator/motor 121 and/or the generator/motor 185 that are coupled to the power shafts 111 and/or 180. As such, components to mitigate this torque may be used such as a flywheel or other heavy dampening or spring coupling system to smooth out torque on the power shafts 111 and/or 180.

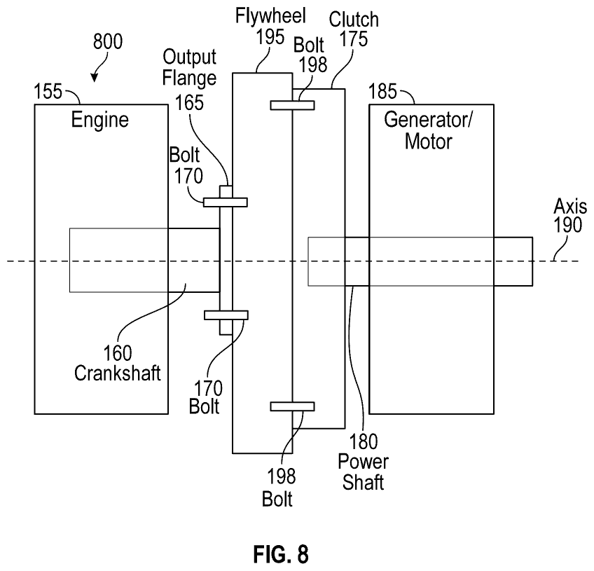

FIG. 8 illustrates an example flexible architecture 800 for an aerospace hybrid system having a flywheel for absorbing oscillatory torque in accordance with an illustrative embodiment. In particular, the flexible architecture 800 includes similar or the same components to that shown in and described with respect to FIG. 1B, but includes a flywheel 195 rigidly connected to the output flange 165 with the bolts 170. The flywheel 195 is further connected rigidly to one side of the clutch 175 by bolts 198. Rotational motion may therefore be translated from the engine 155 through the crankshaft 160, the output flange 165, and the flywheel 195 to the clutch 175. The clutch 175, may in turn engage or disengage with the power shaft 180 to selectively translate the rotational motion received from the flywheel 195 to the power shaft 180. The flywheel 195 may further be, for example, a dual mass flywheel or spring coupling.

In other various embodiments, a flywheel may not be used. For example, further embodiments of dampening systems and apparatuses are described herein that can dampen torque on a power shaft (e.g., the power shaft 111) but do not include a flywheel. Further, in various embodiments, a flywheel and other damping systems or components may be used in combination to dampen or smooth out torque applied to a power shaft.

For example, the power shaft or rotor within the generator/motor itself may be rigidly coupled to a crankshaft of the generator/motor. In this way, the crankshaft and rotor together can dampen the torque pulses on the power shaft or rotor, and may reduce tangential acceleration due to the torque pulses from an engine. In such embodiments, a clutch may be omitted. As such, a dampening system would be internal to the generator/motor, and the footprint and weight of the dampening systems may be less than a flywheel or other dampening system that may be external to a generator/motor. In particular, the rigid coupling of the power shaft or rotor with the crankshaft may increase the inertia of the power shaft or rotor, such that the additional inertia helps prevent the power shaft from slowing down or otherwise rotating in a manner that would make it more susceptible to acceleration from torque pulses of an engine. In such embodiments, the power shaft or rotor and the crankshaft may function similarly to a flywheel.

In various embodiments, a generator/motor having a static inner portion and a spinning outer portion may be used. This may increase an inertia of the spinning portion and may allow the magnets in the generator/motor to spin and avoid being dislodged by torque spikes. In other words, the magnets may be already spinning in the outer portion and therefore may have a constant stabilizing radial force applied in addition to any tangential inertial force due to torque spike acceleration.

A torque damping system may also be configured as part of the power shaft or rotor that connects the output of the engine to the generator/motor. For example, a hub between the power shaft or rotor of the generator/motor may include a coupling that has torsional spring and/or damping properties. Torsional dampening couplings may include an elastomeric component or spring (e.g., made from steel or another metal) that reduces potentially harmful torque impulses from being passed from an engine output to a power shaft or rotor of a generator. Torsional dampening couplings may be similar to or may also be referred to as a resonance damping coupling. For example, such torsional dampening couplings may reduce an overall system weight and size as opposed to systems that use a flywheel or other large dampening system. One or more torsional dampening couplings may be installed at any one or more of, within an engine, between an engine and clutch, in the clutch, between the clutch and the generator, and/or within the generator to achieve dampening before the power shaft or rotor damages components of the generator itself.

Other ways of dampening torque on a power shaft or rotor of a generator may also be used. For example, a magnetic field on a generator may be controlled to pulse it such that it acts upon the power shaft or rotor of the generator to cancel some or all of the torque pulses imparted on the power shaft or rotor by an engine. Such pulses on the field of the generator may be controlled based on a measurement of the torque pulses applied by the engine, and may result in the generator components not being damaged by the diesel engine. For example, the third mode described above where both an engine and a generator/motor apply power to a power shaft, pulses to the power shaft from the generator may both apply power to the power shaft and protect the components of the generator from being damaged. In the other modes described herein, pulses to the power shaft using the generator may be applied whenever the power shaft is being driven in whole in part by the engine. Thus, in order to properly protect the components of the generator in such a method, the pulses applied by the magnetic field of the generator to the power shaft or rotor may be configured to correlate to the torque pulses of the engine to properly counteract those torque pulses.

Further described below are examples of how the flexible architectures described herein may be packaged and/or used in an actual aircraft. For example, certain aircraft may use electric motors to drive propulsion systems, and therefore must have sufficient on-board electrical energy or ways to generate such on-board electrical energy to drive those propulsion systems. In addition, regulations in a given jurisdiction may also require sufficient reserve energy to comply with operational regulations of an aircraft. The flexible architectures described herein may provide such electrical energy for propulsion systems and/or reserve energy such that they systems described herein may work with a variety of electric aircraft. For example, the embodiments herein provide for efficient conversion of jet fuel (or other liquid or gas fuel) to electricity, such that electric aircraft may be powered using widely available fuel sources.

FIG. 9 illustrates a perspective view 900 of an example flexible architecture for an aerospace hybrid system in accordance with an illustrative embodiment. This hybrid unit may be used as the core powerplant of a variety of aircraft types and implementations. The hybrid unit of FIG. 9 is a tightly integrated powerplant that may include some, all, and/or additional elements shown in and described with respect to FIGS. 1A, 1B, 2A, 2B, and/or FIG. 8.

In addition, the hybrid unit may include an integrated cooling system 905 that cools various aspects of the hybrid unit, heat exchangers related to the hybrid unit, or heat sinks such as finned attachments for any aspects of the hybrid unit. A power output 910 may be a power shaft (e.g., the power shaft 110 of FIG. 1A, the power shaft 180 of FIG. 1B or 8) or connected to a power shaft, so that rotational power may be output from the hybrid unit to propulsion systems or other aspects of an aircraft. Electrical connectors 915 may also be used to output electrical power (or input electrical power) as described herein. The electrical connectors 915 may be, for example, an Amphenol Surlok Plus™ connector or equivalent, or may be any other type of suitable connector. In this way, a main bus, such as a direct current (DC) bus, of the hybrid unit may be connected to through the electrical connectors 915 (e.g., the electrical power input/output 125 of FIG. 1, the electrical I/O power 245 of FIG. 2A or 2B). These or other connectors may also facilitate connection to and control of the components of the hybrid unit, such as using a controller area network (CAN) bus, a CAN 2.0 bus, and/or an SAE J1939 bus. Such communications busses may operate at different speeds, such as 250 kilobytes per second (kbps), 500 kbps, 1000 kbps, etc. In various embodiments, the electrical connectors 915 and/or other connectors may be customized for a given application, such as different types of aircraft and the communications and power systems that those aircraft use.

By virtue of the power output 910 and the electrical connectors 915, the hybrid unit of FIG. 9 may output either mechanical power via the power output 910 and/or electric power via the electrical connectors 915 and the DC bus in the hybrid unit (e.g., the electrical power input/output 125 of FIG. 1, the electrical I/O power 245 of FIG. 2A or 2B). Similarly, electrical power may be received via the electrical connectors 915 to drive the power output 910, just as mechanical power may be received via the power output 910 to generate electricity for output via the electrical connectors 915. For example, if an aircraft includes one or more batteries, extra power from a battery may be received via the electrical connectors 915 to boost power applied to the power output 910, such that the power output 910 is driven by both an engine and power from the batteries of an aircraft as described herein.

The hybrid unit of FIG. 9 may further include connectors 925 for connecting the engine to a fuel source. The connectors 925 may be quick fuel connects, such as AN6 quick fuel connects. In this way, the engine may be supplied with fuel to power the power output 910 and/or to generate electricity to be output via the electrical connectors 915. The hybrid unit of FIG. 9 may additionally include mounting hardware 920 for mounting the hybrid unit to an aircraft. While the mounting hardware 920 is shown on the top of the hybrid unit in FIG. 9, mounting hardware in other embodiments may additionally or alternatively be located on any of the top, bottom, sides, etc. of the hybrid unit, so that the hybrid unit may be mounted as desired to an aircraft.

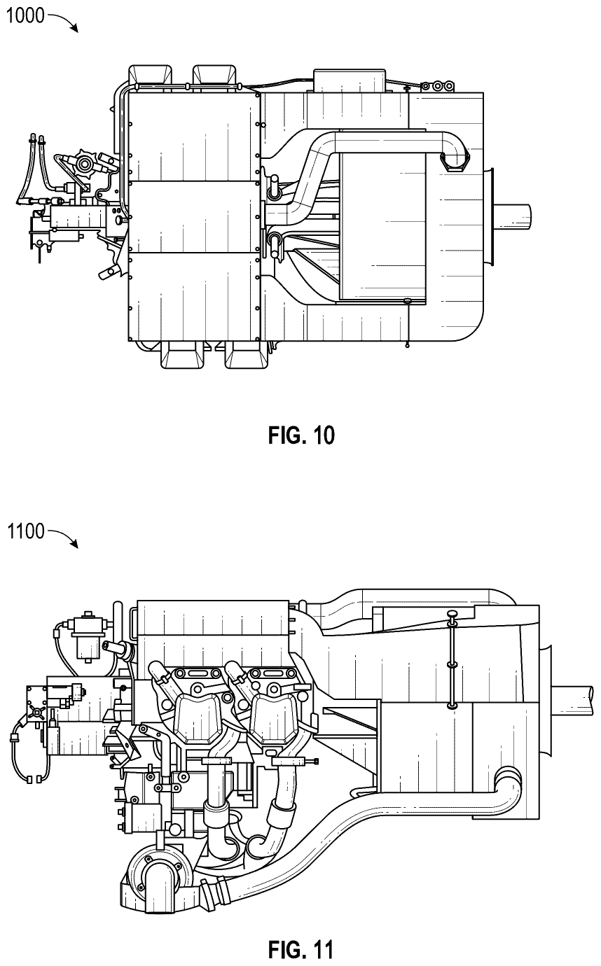

FIG. 10 illustrates a top view 1000 of the example flexible architecture of FIG. 9 in accordance with an illustrative embodiment. FIG. 11 illustrates a side view 1100 of the example flexible architecture of FIG. 9 in accordance with an illustrative embodiment.

Accordingly, the hybrid units described herein may be used to power an electric or hybrid electric aircraft, and may offer better power than a battery pack alone would. For example, a hybrid unit as shown in FIGS. 9-11 may offer better energy density than batteries (e.g., 5 to 7 times better energy density). For example, the hybrid units described herein may have anywhere from 600-1200 or more Watt-hours per kilogram (Wh/kg) equivalent energy density. The hybrid units described herein may also advantageously have better fuel economy than other systems (e.g., 40% better fuel economy than a turbine engine), and may use readily available fuel such as Jet-A, diesel, kerosene, biofuel substitutes, or any other suitable or desired fuel. In other words, the hybrid units herein may include, in a compact package, an engine, a generator, an inverter, and thermal management using air cooling, such that aircraft in which the flexible architecture is installed may advantageously utilize these components as a powerplant. Outputs at various voltages, (e.g., 400 Volts (V), 800V, 1000V, 1200V, etc.) may be supplied from the hybrid architecture, as well as having connections for other accessory or system power (e.g., 28V). The flexible architectures described herein may also be quieter than other systems (e.g., quieter than turbine engine systems). For example, noise may be below 70 decibels (dB) at one hundred feet or less from the current systems.

The flexible architectures described herein may also be scalable. For example, in a larger aircraft, two or more of the flexible architectures described herein may be used. The flexible architectures may also be used in different aircrafts designed for different functions and purposes. For example, the flexible architectures described herein may be useful in urban air mobility (UAM) systems, such as electric vertical takeoff and landing (eVTOL) aircraft, electric short takeoff and landing (eSTOL) aircraft, electric conventional takeoff and landing (eCTOL) aircraft, etc. One example flexible architecture, such as the one shown in FIGS. 9-11, may have the specifications shown in Table 1 below.

TABLE 1
SPECIFICATIONS

| | SI Units | | SAE Units | |
|---|---|---|---|---|
| Max Continuous E-Power | 185 | kW | 248 | hp |
| Max Continuous Shaft Power | 185 | kW | 248 | hp |
| Max Burst Shaft Power* | 370 | kW | 496 | hp |
| Nominal system bus voltage | 400 or 800 | V | 400 or 800 | V |
| Specific Fuel Consumption | 250 | g/kWh | 0.41 | lb/hp-h |
| Ambient temperature range | −40 to 50 | C. | −40 to 122 | F. |
| Ceiling for full takeoff power | 3050 | m | 10.000 | ft |
| Certified ceiling | 6100 | m | 20,000 | ft |
| Dimensions (L × W × H) | 140 × 93 × 84 | cm | 55 × 37 × 33 | in |
| Mass, dry** | 295 | kg | 650 | lb |

*Max burst shaft power depends upon battery configuration
**Dry mass includes engine, generator, inverter, and thermal systems

As shown above, a 185 kW hybrid unit may be provided. Accordingly, two hybrid units may be provided in a given aircraft to provide 370 kW of power.

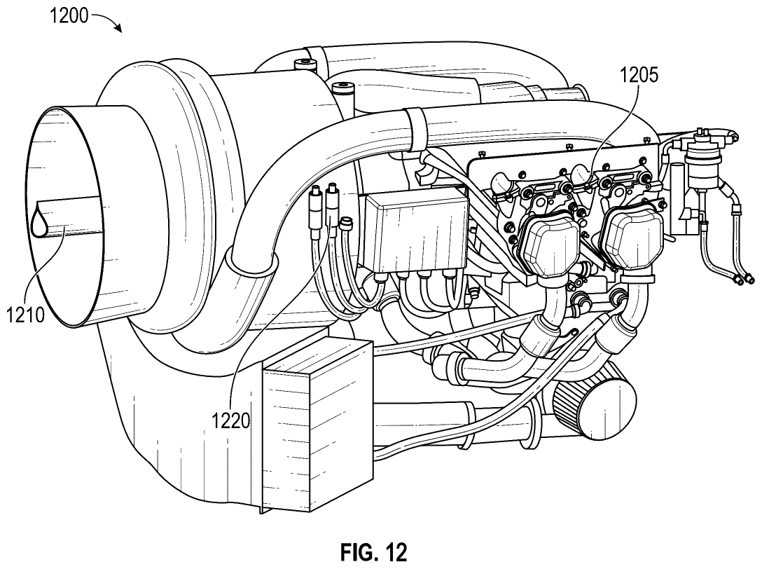

FIG. 12 illustrates a perspective view 1200 of another example flexible architecture for an aerospace hybrid system in accordance with an illustrative embodiment. The flexible architecture of FIG. 12 includes an engine 1205 and a generator, which is hidden or not visible because of other components such as the cooling ducts of the system. However, like the hybrid unit of FIGS. 9-11, a mechanical output power 1210 and electrical output power 1220 (which are also both optionally capable of receiving power as well) are provided.

As such, the various embodiments herein provide for a hybrid electric powerplants that may be incorporated into various different types of aircraft in the aerospace market. In doing so, aircraft manufacturers may not have to build their own systems that are made up of an engine, a generator, power electronics, cooling systems, and/or control systems to provide power to those aircraft. This may be advantageous, as a development process to create a powerplant system and certify it to aerospace standards may last 4+ years and may cost more than $10M.

As such, the hybrid powerplants or flexible architectures described herein may be design, manufactured, etc. separably from the design of the aircraft. A few aspects of the flexible architectures may be customized as desired by an aircraft manufacturer, but in a way that does not cause the total system to be redesigned or reconfigured. The embodiments herein therefore provide for an integrated unit that includes the engine, generator, power electronics, cooling systems, and/or control systems in one package to be installed on an aircraft. Combining these elements into a single standalone unit further advantageously allows for that unit to go through the Federal Aviation Administration (FAA) certification process as a system. Then, multiple aircraft manufacturers may use the certified system, removing that certification burden and development burden from the aircraft developer as well as adding efficiencies where multiple aircraft manufacturers will not have to seek certification of many different powerplant systems specifically designed for their aircraft.

By providing a combined unit having an engine, generator, power electronics, cooling systems, and/or control systems, the hybrid flexible architectures described herein may be optimized as a whole system rather than as individual components. entire system rather than optimization of the pieces. Additionally, such a hybrid unit may be used in multiple aircraft designs, whereas systems designed as part of an aircraft design process are configured such that it is difficult to reapply them elsewhere. Having a hybrid unit that may be applied in multiple market segments and aircraft designs with common power requirements leads to faster development of aircraft where a major component (e.g., the hybrid units or flexible architectures) of an aircraft is already certified and in production.

Hybrid electric systems for aviation have historically been designed from scratch for each application/aircraft. Such a process is inefficient and addressed by the embodiments herein. For example, some aircraft have unique powerplants designed specifically for the aircraft. Such a solution may include custom engine, generator, power electronics, control systems, cooling systems, battery pack, propulsion motors, and/or propellers. The embodiment herein provide for a compact hybrid system for an aircraft that may make up one half of two distinct halves within an aircraft power and propulsion system: upstream and downstream ends of a powertrain (such as a hybrid powertrain as described herein).

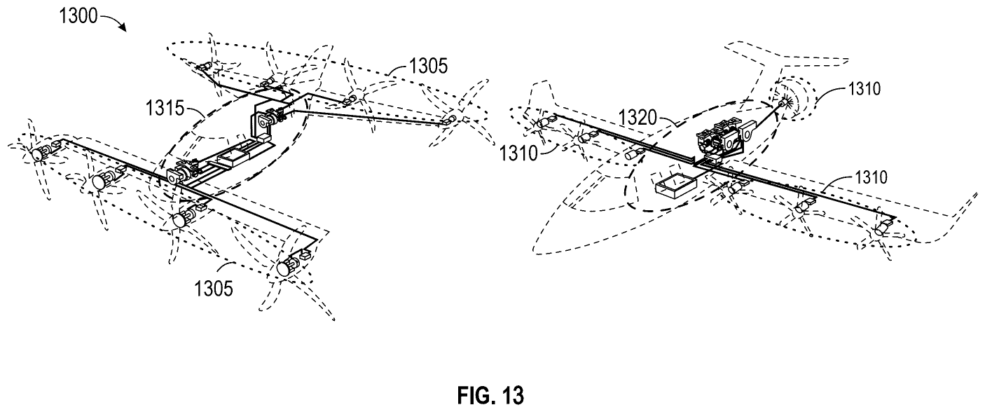

FIG. 13 illustrates example downstream and upstream components for propelling an aircraft 1300 in accordance with an illustrative embodiment. For example, downstream components 1310 of an aircraft system may include motors, rotors/propellers, attitude control components, etc., that are more related to the specific design of an aircraft. Upstream components 1305 of an aircraft that may be repeatable within different aircraft may include any of engines, generators, batteries, power distribution, fuel, generator noise abatement, etc.

Specifically, the upstream end of the powertrain may include hybrid powertrain elements responsible for producing electrical power. Such upstream components 1305 may include the engine, generator, power electronics, control systems (for the upstream power generation components), cooling systems (for the upstream components), battery pack, and/or fuel. The downstream end of the powertrain may include hybrid powertrain elements responsible for turning the electrical power into thrust, attitude control, and/or active control of aerodynamics. These downstream components 1310 may further include electric motors, propellers, motor controllers, and/or control systems for the propulsion system.

As such, there may be common upstream powertrain needs across very different electric aircraft designs that are of similar sizes and total power requirements. However, the downstream powertrains may have little consistency from one aircraft to the next and therefore these components may not be standardized to work on many aircraft designs the way the upstream components can. Furthermore, the upstream elements that lend themselves to standardization may include the components that are linked to the power requirements but not the total energy requirements. In the case of the engine, generator, power electronics, cooling systems, and/or control systems, these elements of the upstream powertrain may be sized to fit a specific power requirement (kW or hp) of an aircraft. However, the quantity of fuel and the size of the battery pack may be driven by total energy requirements (kWh or hp hr) and these may vary from aircraft to aircraft. In such embodiments, the volume of fuel may be scaled by changing the size of the fuel tank to match the requirements of the aircraft design, and the capacity of the battery pack in kWh may be scaled by adjusting the number of parallel stacks of cells within a battery pack or by adding additional battery packs.

Therefore, provided herein are embodiments for supplying a hybrid powerplant that tightly integrates the engine, generator, power electronics, control systems (for the power generation system), and/or cooling systems in a weight-efficient and space efficient manner that can be certified as a standalone unit designed to provide propulsive power that is separable from the aircraft.

In addition, as described herein, a rotor inside the generator may be optimized to serve multiple purposes in the context of a hybrid powerplant. Conventional combustion engines may have a flywheel mass attached to the rotational shaft to enhance smoothness of operation. However, in the context of an aerospace system it may be unattractive to add extra mass. When an engine is coupled to a generator in a hybrid powerplant as described herein, the rotor in the generator may be designed to withstand any torque impulses from the engine and it may be designed to be the rotating mass that the engine utilizes for smoothness of operation.

Further, while auxiliary power units are known in the prior art, these systems may be designed for different purposes than as a primary source of propulsion power for an aircraft, and therefore may not have control systems capable of being certified to the standards required for use in propulsion. Additionally, such systems may be designed without the cooling systems, leaving that aspect to the airframe designer. As such, these systems are not certified to Part 33 (FAA regulations for aircraft powerplants). Also, these auxiliary power unit systems are designed to be lightweight auxiliary systems that are used intermittently rather than for highly efficient propulsion systems that are used in all phases of flight. Additionally, auxiliary power units may be designed to produce alternating current (AC) power, whereas hybrid electric powerplants as described herein may produce direct current (DC) power so that the hybrid electric powerplants may be coupled to a large propulsive battery pack, as battery packs provide and are charged using DC power.

Turbogenerators are a type of adapted auxiliary power units that have been proposed for hybrid power. Such systems lack cooling system integration that provides an airframe developer with a cooling system that is part of the hybrid powerplant. As such, airframe developers may be left to design their own cooling systems to accompany use of a turbogenerator. Using the embodiments herein, separate cooling systems for cooling the hybrid powerplants described herein may advantageously not need to be designed or developed for particular airframes, as such cooling systems are already included in the flexible architectures described herein.

As such, the flexible architectures and hybrid electric powerplants described herein advantageously provide an engine that converts liquid fuel (or gaseous fuel) into rotational mechanical power, a generator coupled to the engine that is configured to convert the rotational mechanical power to electricity, and/or power electronics coupled to the generator that are configured to convert the direct AC output of the generator to high voltage DC power. The flexible architectures and hybrid electric powerplants described herein further advantageously provide control systems that are configured to vary the power output of the engine to match the power demand on a main propulsive electrical bus of an aircraft to meet the demands of an aircraft for electric power.

Hybrid powerplant control systems, power electronics, generator, and/or engine designs described herein may further comply with regulatory requirements for the reliability of propulsive aerospace systems (e.g., failure should have a probability of less than 10⁻⁶ or ten to the power of negative six). Flexible architectures and hybrid electric powerplants may further include a control interface that enables the flexible architecture or hybrid powerplant to communicate with a vehicle-level flight control systems to enable propulsive power commands to be provided from the vehicle-level flight control systems to the hybrid-powerplant control systems, and also advantageously provide for the hybrid-powerplant control systems to send status messages back to the vehicle-level flight control systems (e.g., feedback for use in controlling the flexible architecture or hybrid powerplant). Flexible architectures and hybrid electric powerplants may further include cooling systems that maintain the temperature range of the generator, power electronics, and/or engine over a full range of operating power output of the flexible architectures and hybrid electric powerplants described herein.

Various embodiments of flexible architectures or hybrid electric powerplants described herein may further include control systems that vary power output by varying engine torque and/or maintain rotations per minute (RPM) substantially constant over a significant range of power output. Such embodiments may provide for faster response of the flexible architectures or hybrid electric powerplants by eliminating throttle lag and a longer response time relating to system rotational inertia.

Various embodiments of flexible architectures or hybrid electric powerplants described herein may further include the option to provide a portion of the engine's power output as mechanical shaft power and a portion provided as DC electrical power. Various embodiments of flexible architectures or hybrid electric powerplants described herein may further include that the engine may be a piston engine, diesel piston engine, turbine engine, rotary engine, or other forms of combustion engine. Various embodiments of flexible architectures or hybrid electric powerplants described herein may further include examples where the rotor of the generator is designed to be a flywheel for the engine. Various embodiments of flexible architectures or hybrid electric powerplants described herein may further include a clutch between the engine and generator to enable operation of the generator as a motor that can be operated while the engine is shut down in some types of parallel hybrid installations as described herein.

### DC Bus Components

Described herein are various embodiments for implementing a hybrid-electric aircraft. Such an aircraft may utilize a high voltage electrical bus to distribute power to various components of the aircraft, such as motors for propulsion mechanisms of the aircraft. In such a hybrid-electric aircraft, it may be desirable to stabilize the high voltage electrical bus within a specific, predetermined voltage range (e.g., around a nominal voltage level) so that the propulsion motors may perform adequately. Various embodiments described herein may specifically use a direct current (DC) bus, so maintaining a desired DC voltage range may be desirable. Advantageously, the various embodiments herein provide for efficiently maintaining a desired DC voltage range on a DC bus by connecting at least one battery or supercapacitor directly to the DC bus, and further maintaining a sufficient charge on the at least one battery or supercapacitor to maintain the desired DC voltage range on the DC bus. Such embodiments may prevent voltage spikes that may be damaging to components of a hybrid-electric or electric aircraft (e.g., electric motors and inverters for propulsion) and avoid voltage spikes or sags that may negatively impact the reliability and/or performance and safety of the aircraft or systems of the aircraft.

In electrified aviation, various embodiments of an overall architecture may include one or more electric power creation devices (e.g., an electric generator) connected via a low-impedance connection to a high voltage DC bus and feeding electrical power and energy onto that bus. In the same vehicle and attached to that same DC bus may be one or more power consuming devices (e.g., electric motors) that receive electrical power and energy from that DC bus. Various embodiments of electrified aircraft may also include energy storage devices such as battery packs or capacitors (e.g., supercapacitors), which may receive or deliver power as desired depending on bus voltage and battery pack voltage.

If a high-voltage electric generator is directly generating DC power or is operating through a passive rectifier, for example, the DC voltage created by the motor may be a function primarily of motor rotations per minute (RPM) of the shaft rotating the electric generator. A permanent magnet electric motor, for example, may create a voltage based on rotational speed (RPM). For many uses, the coupling of voltage with RPM may create an issue for motor control that limits the value of that electric motor in a system. To gain additional usefulness from a brushless motor without permanent magnets, an external voltage reference may be used to maintain a desired voltage level. A unique problem in aviation is that flight safety requires precise control of power consumers over a wide range of flight conditions (electric motors driving fans, propellers, or other devices) that may not match the characteristics of contributors (such as an electric brushless generator). If a high-voltage generator used is turning slower than expected for any reason, the bus voltage may be lower than desired and any motors on that bus may perform below expectations, which may lead to an unsafe or undesirable condition. If such a high-voltage generator is turning faster than expected, bus voltage may be high and motor performance may again be outside expected or desired values. As such, it may be desirable for applications of generators and motors sharing a common bus to design the generators and motors used accordingly. For electrified aviation, precise control of any motor(s) is desirable to provide lift, thrust, aircraft attitude, etc. for an aircraft. As such, as compared to other, non-aviation related implementations, it is desirable to have better control over a power supplied to any motor(s) (e.g., over the DC bus) by maintaining power supplied to the motor(s) at a voltage that keeps the motor(s) operating at a desired performance level. In addition, the power supplied to the motor(s) may be quickly adjustable so that a pilot or control system of an aircraft may control the motor(s) over a wide range of use as needed (e.g., provide a pilot or control system with a flexible, wide range over which they may control the motor(s)). In various embodiments, inverters may be used to regulate an output voltage of an upstream electric generator(s), which may be used to feed a high voltage bus. Inverters may also be used to precisely control downstream motors under varying load conditions.

Inverters may allow a system designer to expand an operating envelope of any motors and/or generators by controlling current. In order for these inverters to function properly, a bus voltage feeding power to the inverters may advantageously be set and maintained by other methods besides motor RPM (as voltage on a bus may be difficult to control precisely where only motor RPM is used). The maintenance of the bus voltage relates to capacitance and the expected variations in load present under all system operating conditions. If that bus has loads that are varying too rapidly or capacitance (which acts like inertia in an analogous mechanical system) that is too low, for example, then the high voltage bus and power electronic system may become unstable.

In various embodiments, bus voltage may be established and maintained using battery pack(s), capacitor(s), or any combination thereof. Such devices may add capacitance and/or electrical inertia to the bus and are passive, meaning their intended function is ruled completely by physics and may not require control or intervention (e.g., by a controller or control system). Supercapacitors (or ultracapacitors) additionally have a desirable feature of high capacitance, though they typically lack significant energy storage. Supercapacitors may respond to very rapid fluctuations with enormous power (e.g., energy over time). In short, they may provide stability to a bus for fluctuations that are relatively short in duration, low in amplitude, or where the product of those two values is relatively low. Batteries may also be desirable because they have significant capacitance for bus stability and may also store high energy. Batteries may not be able to respond to a change in voltage as quickly as a supercapacitor, as batteries often have more limited rate of power applications, particularly in charging (where discharging power capacity is often 10× or more higher than charging capacity). For example, if it is necessary to pull current off a bus to maintain a desired voltage level (e.g., charge a battery), a battery may not absorb that current as quickly as would be desired in certain embodiments (depending on the specific characteristics of a selected battery). In some embodiments, however, one or more battery packs alone may be sufficient to maintain a desired voltage level on a bus.

Accordingly, various embodiments are described herein that enable independent control of one or multiple upstream electric generators and downstream motors by adding a battery pack and/or supercapacitor bank with an appropriate design to maintain a desired voltage on a DC bus. With an architecture where the voltage and capacitance of those storage elements are directly electrically connected to the main motor control elements on the bus (and not shielded by other switches, chargers, or like devices), the battery pack and/or supercapacitor bank provide a lightweight and effective anchor or setpoint for a high voltage DC bus.

A battery pack in an aircraft may be deployed along with a hybrid-electric generation system to support system safety standards applied to flight articles. If these battery packs and/or supercapacitors are chosen not only to provide required power or energy but are also set at a correct or desired voltage and are connected to high voltage motor controllers, the battery pack and/or supercapacitor bank may provide a second and valuable benefit of bus stabilization by connecting the battery pack and/or supercapacitor bank directly to a DC bus. The battery pack and/or supercapacitor bank may also be advantageously chosen for a given aircraft such that it has a target voltage, though actual voltage on the bus may naturally fluctuate some with state-of-charge (SOC) and varying electric loads. The battery pack and/or supercapacitor bank may also be advantageously chosen so that the actual voltage is unlikely to go outside of a desired range. In instances where the actual voltage does go out of the desired range or is expected to go out of the desired range, a controller of the aircraft or a hybrid-electric genset in the aircraft may adjust the power (e.g., torque) supplied to the generator to add or reduce electric power supplied to the DC bus to maintain the voltage within a proper, desired range. RPM may further be maintained at a constant or relatively constant level or within a predetermined range. Therefore, power supplied to the generator or otherwise output to a power shaft may be adjusted by adjusting the torque output by the engine rather than through adjustment of the RPM of the output of the engine. It may further be desirable to maintain an actual voltage set point that may fluctuate at a range that remains within desired tolerances for operating electric motors or other components of an aircraft. In addition, a battery pack may advantageously serve as an auxiliary source of power to drive motors or other components of an aircraft in the event of a fault in the generator(s) or other component of a hybrid-electric genset. This may therefore add a level of system safety and fault tolerance.

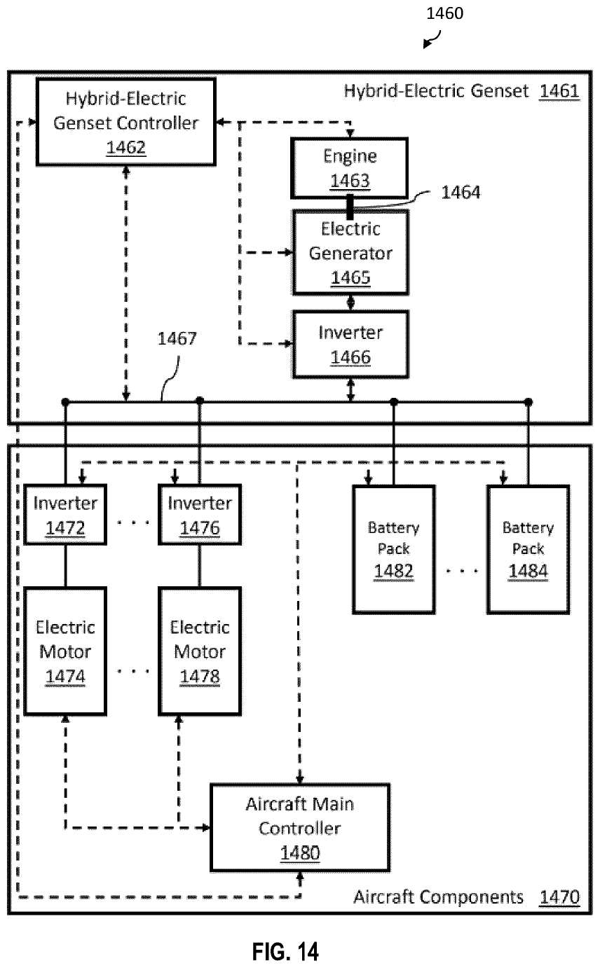

FIG. 14 is a diagrammatic view of an example system 1460 for providing a direct current (DC) bus with a stable voltage, in accordance with an illustrative embodiment. The system 1460 includes a hybrid-electric genset 1461, which includes a controller 1462, an engine 1463 connected to an electric generator 1465 by a shaft 1464, an inverter 1466, and a direct current (DC) bus 1467. The engine 1463 may supply mechanical (e.g., rotational) power to the electric generator 1465 via the shaft 1464 so that the electric generator 1465 may produce electric power (e.g., alternating current (AC) power). The AC power from the electric generator 1465 may be converted to DC power by the inverter 1466 and supplied to the DC bus 1467. The inverter 1466 may also be able to convert AC power from the DC bus 1467 into AC power that may be used by the electric generator 1465 to provide power output to a shaft (e.g., where the electric generator 1465 acts as a motor to power a component of an aircraft such as a propulsion mechanism). The controller 1462 may control any of the components of the hybrid-electric genset 1461 (e.g., control an RPM that is output to the electric generator 1465). The controller 1462 may also measure characteristics of the DC bus 1467, such as voltage on the DC bus and/or current flowing through the DC bus 1467.

The system 1460 further includes aircraft components such as inverters 1472 and 1476 connected to the DC bus 1467, electric motors 1474 and 1478 connected to the inverters 1472 and 1476, a controller 1480, and battery packs 1482 and 1484. In various embodiments, the aircraft components may have supercapacitors instead of or in addition to the battery packs 1482 and 1484. In various embodiments one or more battery packs and/or supercapacitors may be included as part of the hybrid-electric genset 1461 and connected directly to the DC bus within the hybrid-electric genset 1461, whether or not the aircraft components have separate batteries and/or supercapacitors. While FIG. 14 shows multiple connections running from the DC bus 1467 of the hybrid-electric genset 1461 to the aircraft components 1470, other configurations are contemplated herein, such as a single connection to another bus of the aircraft components 1470, or where the DC bus 1467 itself is part of the aircraft components 1470, etc. The controller 1480 may be in communication with the control 1462. In this way, the controller 1480 may transmit information to the controller 1462 about how the inverters 1472 and 1476, electric motors 1474 and 1478 are being controlled/used at a present time or how the controller plans to use those components in the future. The controller 1480 may also monitor and measure the state of the battery packs 1482 and 1484 and send information related to that state (e.g., any measurement related to the charge state, voltage, current flowing into or out of battery, etc.) to the controller 1462. In embodiments where a battery or supercapacitor is included in the hybrid-electric genset 1461, the controller 1462 may monitor such components for similar information.

In various embodiments, fewer, additional, or different elements to those shown in FIG. 14 may be included in an aircraft.

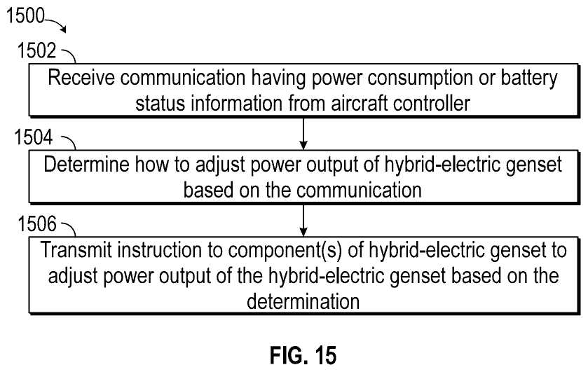

FIG. 15 is a flow chart illustrating an example method 1500 for maintaining a stable DC bus voltage based on communications from an aircraft-level controller, in accordance with an illustrative embodiment. At an operation 1502, a controller (e.g., the controller 1462 of FIG. 14) may receive a communication that includes power consumption or battery status information from an aircraft controller (e.g., the controller 1480 of FIG. 14). The power consumption information may relate to how power is currently being used by inverters or electric motors, for example, of an aircraft. The power consumption information may also relate to how will be used by the inverters or electric motors of an aircraft (e.g., information on how the controller is intends to increase or decrease power supplied to motors at a specified time in the future). The battery status information may include a charge state, actual voltage of, and/or current flowing into or out of the batteries or supercapacitors of a system.

At an operation 1504, a controller may therefore be able to determine how a power output of a hybrid-electric genset should be adjusted to maintain a desired voltage range on a DC bus. For example, if a battery's charge level is too low such that it is in danger of not being able to maintain a desired voltage, the controller may transmit instructions at an operation 1506 to increase the power output of the hybrid-electric genset so that there is sufficient power to charge the battery. In another example, if a motor of the aircraft is currently using or is expected to require significantly more power than is currently being used, the controller may transmit instructions at an operation 1506 to increase power output of the hybrid-electric genset. The power output may also similarly be decreased. In either instance, the controller may adjust this overall power output to the DC bus by varying the RPM supplied to an electric generator by an engine. As such, while the battery packs and supercapacitors may reduce a need to provide real time adjustments to power output of a hybrid-electric genset, as the battery packs and/or supercapacitors may maintain the DC bus at a desired voltage level, some control or adjustment of the RPM and therefore output power to the DC bus may still be desirable in various embodiments.

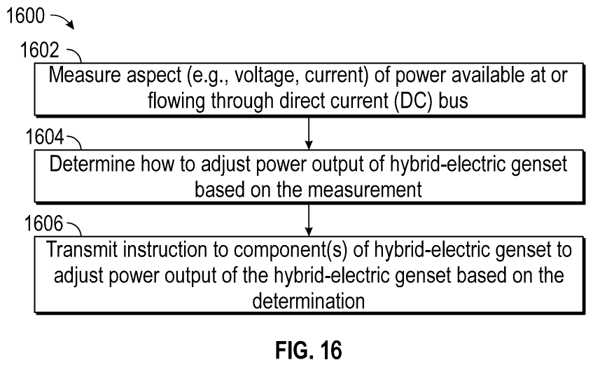

FIG. 16 is a flow chart illustrating an example method 1600 for maintaining a stable DC bus voltage based on measurements by a hybrid-electric genset-level controller, in accordance with an illustrative embodiment. The method 1600 is similar to the method 1600, except it contemplates measurements that may be made by a hybrid-electric genset controller itself (e.g., the controller 1462), rather than receiving such measurements or information from another controller (e.g., an aircraft system-wide controller such as the controller 1480 of FIG. 14).

At an operation 1602, aspects of power available at or flowing through a DC bus is measured by the controller. If the DC bus is measurable by a system-wide aircraft controller, the operation 1602 may be carried out by the system-wide aircraft controller as well. Similarly, if batteries and/or supercapacitors are packaged as part of a hybrid-electric genset rather than being positioned as part of an overall aircraft system, the controller may at operation 1602 also measure a state of the batteries/supercapacitors (e.g., charge state, current, voltage, etc.). At an operation 304, the controller determines how power output of the hybrid-electric genset should be adjusted based on the measurements. For example, if a DC bus voltage is getting close to going outside of a desired range, it may be desirable to transmit instructions at an operation 306 to the components of the hybrid-electric genset to adjust power output of the hybrid-electric genset based on the determination at the operation 304 to ensure the DC bus voltage stays within a desired voltage range.

### Thrust Control Spanning Multiple Operation Modes

As described herein, an example hybrid-electric powerplant may have an engine; a motor/generator; a high voltage battery pack; a parallel hybrid output shaft operably connected to a propeller, fan, or gearbox; and high voltage connections that allows the power output of the engine to be split or blended between series power generation and direct shaft power. As also discussed herein, such an architecture provides for multiple different modes of operation. In some embodiments (e.g., as shown in FIG. 14), instead of the parallel hybrid output shaft being used to provide mechanical power to a propeller, fan, gearbox, etc. of a propulsion mechanism of an aircraft, the output shaft may provide power to a generator (e.g., the generator/motor 121, 185, 235, 1465, as described herein). As such, in various embodiments, the thrust control described herein may have usable ranges associated with such a system.

For an aviation-based system, it may be desirable to reduce pilot workload, whether mental or physical. Flying an aircraft may take considerable focus, and any system that can offer reduced workload, reduced judgment, lower required use of memory or checklists, etc., the less likely it is that the pilot or operator will make a mistake. In an automated or manual lever system where a controller of a hybrid-electric powerplant receives a request for thrust from a system-wide controller of an aircraft, such methods as described herein also provide for a simple design and/or interoperability with a greater number of aircraft—as aircraft controllers may simply request a given thrust level without the need to program the aircraft controller to understand the varying flight modes made available by a hybrid-electric powerplant.

Pilots may be also advantageously be used to a thrust lever. Levers in an aircraft cockpit may include a throttle lever used to direct the output power from one or more engines. Levers may also relate to propeller thrust, with a forward motion resulting in higher thrust, faster climb, and/or faster cruise speed. Thus, in embodiments with a physical lever, a pilot may advantageously already be familiar with a mechanism for controlling a powerplant to get more thrust without having to re-train a pilot regarding the multiple modes of operation of the hybrid-electric powerplants described herein.

As such, embodiments described herein the physical layout of a thrust lever spanning at least two operational modes of a series/parallel hybrid powerplant, and also the underlying controller aspects of this system. For example, as shown in FIG. 2A, the controller 205 of the flexible architecture 201 may receive a signal from the main aircraft controller 220 indicative of a request for a given thrust level, which may be related to a physical position of a lever or may be calculated by the main aircraft controller 220 or another computing device.

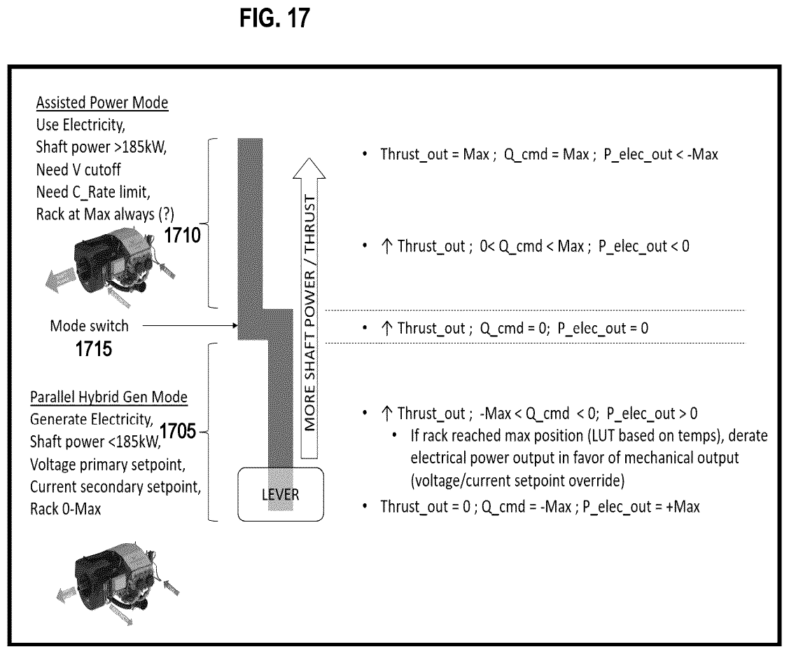

In the first range (e.g., a first subset of positions within the overall range of positions), (e.g., a Parallel Hybrid Gen Mode), and toward the bottom of the first range, the system may begin with providing high voltage electrical current (power) to the high voltage bus to drive distributed electric propulsion. Engine RPM may be at a high set point that provides maximum engine efficiency and the motor/generator may be controlled to maintain bus voltage meaning that electrical output is matched to aircraft load and voltage is stable. Engine output may range from low power to maximum power, and will be dictated by the load on the HV bus only. The first range, for example may be shown by range 1705 in FIG. 17.

From this state, if the pilot desires to engage the output shaft to spin a mechanical device such as a pusher prop or a gearbox to drive a rotor, the pilot may begin to move the thrust lever forward to request thrust to be output to the direct drive shaft. If the electrical load does not require full engine power previously, and as long as the addition of requested shaft power also does not require full engine power, then moving the lever forward while the other automation present in the system maintains bus voltage (and therefore DC output current), the power blending begins. The power required to maintain the HV bus may remain, and power may begin to also flow to the output shaft, and the engine is supplying both mechanical shaft and electrical outputs simultaneously.

This continues until the point (e.g., point 1715 in FIG. 17) is reached where the maximum power available from the engine has been requested (both via the thrust lever and the deterministic automated control and maintenance of bus voltage in the presence of DC current load). At this thrust request the parallel hybrid system output may be maximized, whether by wide-open throttle, maximum mechanical fuel rack, or other such engine control range. This coincides with the mid-point of the thrust lever range, labelled as Mode Switch in FIG. 17.

Additional thrust request (more shaft power to the pusher prop or gearbox), if the DC current load from the distributed electric propulsion has not been reduced, may require power to flow out of the battery pack and onto the HV bus. At this stage (e.g., range 1710 in FIG. 17), labelled Assisted Power Mode, more of the engine power is being fed to the output shaft and the electrical power needs of the HV bus are being partially satisfied by the generator and partially satisfied by the battery pack.

This operation may continue until the pilot receives a warning related to the battery pack performance and safety. Such warning may relate to State of Charge (SOC), HV bus voltage (which will drop when batteries discharge), or battery temperature due to extended discharge. Once a limit has been detected and reported, the pilot or operator may make choices that enable reduced thrust request from the output shaft. The pilot or operator may then reduce the position of the thrust lever to rebalance the system and potentially return to a phase with automatic charging of the battery pack from the hybrid powerplant system (e.g., the first range referred to as Parallel Hybrid Gen Mode). In various embodiments, certain choices may also be made automatically by a processor or controller on board. For example, if the HV bus voltage drops below a threshold, battery temperature goes above a predetermined threshold, state of charge (SOC) goes below a predetermined threshold, etc., the processor or controller/may automatically control what power output mode (or range of FIG. 17) the system is in, whether a physical controller manipulated by a pilot or other controller is in a particular range or not.

In various embodiments, additional or different modes of operation of a hybrid-electric powerplant may be incorporated into operation by a lever and/or in response to request for a thrust level from a controller. For example, such embodiments may incorporate three or more different modes, or may incorporate modes other than the modes shown in and described with respect to FIG. 17. For example, a third mode may be referred to as a whisper mode where the engine is not operated and the motor/generator is powered by a battery pack to drive a mechanical output shaft. Such a mode may output a lower overall power than the two modes above. Thus, such a mode may be applied at a lowest range of a lever or thrust request, with one or more other modes being associated with other ranges of motion of a lever or thrust request.

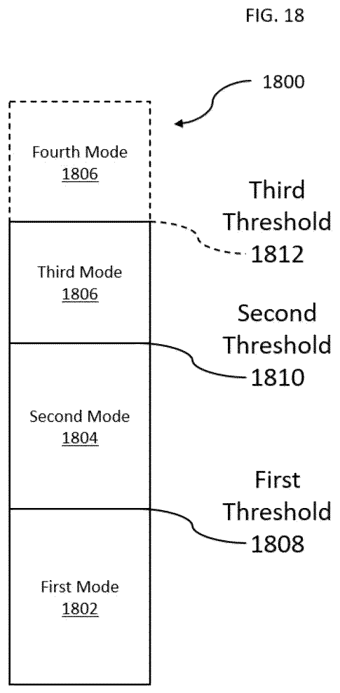

For example, FIG. 18 shows example operation modes 1800 in which an example hybrid architecture may be controlled. While FIG. 17 demonstrated two modes, FIG. 18 demonstrates at least three modes, as well as dashed lines indicating a possible fourth mode that may be implemented in embodiments. The first threshold 1808, second threshold 1810, and third threshold 1812 may represent different levels of desired total output of a system, which may be in the form of electrical or mechanical output. For example, if the system includes the hybrid-electric genset 1461 of FIG. 14, the total output may be the total amount of power delivered to the bus 1467 by a combination of the electric generator 1465 and the battery packs 1482, 1484. Once a desired amount of output power passes the first threshold 1808, the system may shift from the first mode 1802 of operation to the second mode 1804 of operation. Similarly, once the desired amount of power moves through the second mode 1804 toward the third mode 1806 of operation (with a lower amount of power being delivered in a region of the second mode 1804 closest to the first mode 1802 and a highest amount of power in the second mode 1804 being delivered closer to the third mode 1806), at the second threshold 1810 the system may shift into the third mode 1806 of operation. A similar effect may occur when a desired amount of power exceeds the third threshold, and the system may shift into a fourth mode 1806.

In various embodiments, the modes may be associated with different outputs or modes as described herein. For example, the first mode 1802 may be a mode where only battery power is used to output power. The second mode 1804 may be where power from an engine is output to both a bus (e.g., to charge batteries) and mechanically to a propulsion mechanism. In the example of FIG. 14, such a second mode 1804 may be where all power from the engine 1463 and the electric generator 1465 is output to a bus 1467, and some of the power is used by electric motor(s) 1474, 1478 and some of that power is used to charge batteries 1482, 1484. The third mode may be where both power from an engine and power from a battery is used to power a propulsion device (e.g., where the engine 1463 and the electric generator 1465 as well as the batteries 1482, 1484 power electric motor(s) 1474, 1478).

Other modes as described herein may be associated with any of the first, second, third, fourth, etc. modes of FIG. 14 in various embodiments. For example, a mode may involve a hybrid generator mode as described herein, where the engine may be engaged with the power shaft using the clutch to drive the generator/motor and output electrical power from the generator/motor. Another mode may be a direct drive engine mode as described herein where an engine may drive a power shaft to mechanically or otherwise power a propulsion mechanism, while the power shaft spins within the generator/motor without receiving or outputting electrical power at an electrical power input/output of the generator/motor. Another mode may be an augmented thrust mode as described herein, where both an engine and a generator/motor are used to drive a power shaft simultaneously to send power to a propulsion mechanism. Another mode may be a direct drive generator/motor mode as described herein, where a generator/motor alone may provide power to a propulsion mechanism based electrical power received at the electrical power input/output (e.g., from a battery pack(s)). Another mode may be a split engine power mode as described herein, where an engine may be used to drive the power shaft and a generator/motor to output power via an electrical power input/output and the power shaft.

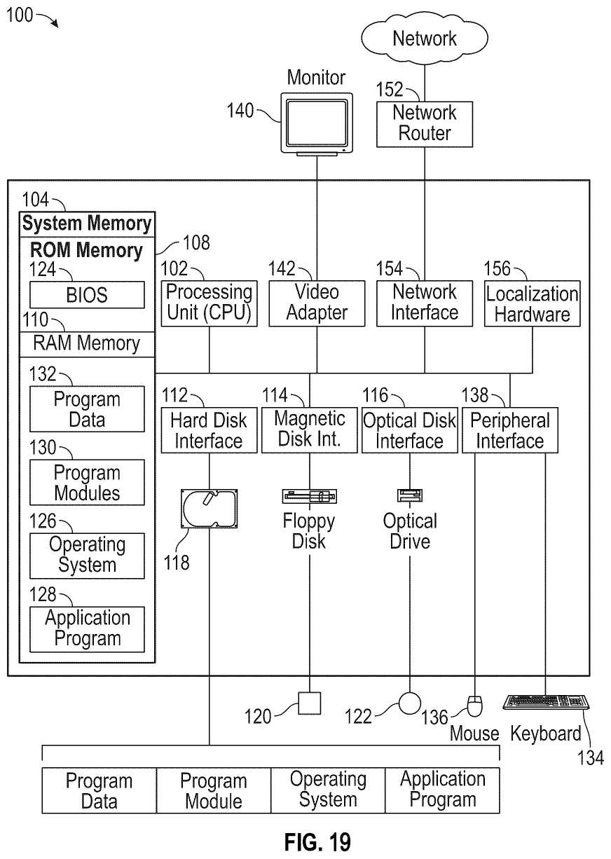

FIG. 19 is a diagrammatic view of an example of a computing environment that includes a general-purpose computing system environment 100, such as a desktop computer, laptop, smartphone, tablet, or any other such device having the ability to execute instructions, such as those stored within a non-transient, computer-readable medium. Various computing devices as disclosed herein (e.g., the processor/controller 205, the controller 220, the processor(s)/controller(s) 280, the hybrid-electric genset controller 1462, the aircraft main controller 1480, or any other computing device in communication with those controllers that may be part of other components of an aircraft) may be similar to the computing system 100 or may include some components of the computing system 100. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 306, respectively, allow for reading from and writing to a hard disk 118, reading from or writing to a removable magnetic disk 120, and/or for reading from or writing to a removable optical disk 122, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, and/or peripheral memory devices may be used to store computer executable instructions comprising an operating system 126, one or more applications programs 128 (which may include the functionality disclosed herein, for example), other program modules 130, and/or program data 122. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 132. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In some instances, the localization hardware 156 may include, for example only, a GPS antenna, an RFID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

In an illustrative embodiment, any of the operations described herein may be implemented at least in part as computer-readable instructions stored on a computer-readable medium or memory. Upon execution of the computer-readable instructions by a processor, the computer-readable instructions may cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or from practice of the disclosed embodiments. It is intended that the scope of the invention be defined by the claims appended hereto and their equivalents.

What is claimed is:

1. A control system for adjusting output of a hybrid-electric powerplant of an aircraft comprising:
an input of a controller configured to receive commands;
the controller configured to set the mode of operation of a hybrid system based on the commands, wherein the mode of operation comprises an output mode of the hybrid-electric powerplant, and wherein there are at least two modes of operation, and further wherein:
a first command provided to the input causes the hybrid electric powerplant to:
operate an engine having a mechanical output;
output first electrical energy from a motor/generator driven by the mechanical output of the engine; and
drive a propulsion mechanism by the mechanical output of the engine; and
upon receipt of a second command, the hybrid electric powerplant is configured to:
operate the engine having the mechanical output;
receive second electrical energy at the motor/generator;
drive the mechanical output with the motor/generator using the second electrical energy; and
drive the propulsion mechanism by the mechanical output.

2. The control system of claim 1, wherein the input comprises a lever configured to move in response to a force from a pilot or operator such that different positions are used as commands that correspond to different modes.

3. The control system of claim 1, wherein the input comprises an electrical connection with a computerized flight control system, wherein the controller is configured to receive, from the computerized flight control system, electronic commands that correspond to different modes.

4. A lever for adjusting output of a hybrid-electric powerplant of an aircraft comprising:
a lever configured to move over an overall range of positions, wherein movement of the lever adjusts the output of the hybrid-electric powerplant between at least two modes of operation, wherein:
in a first subset of positions within the overall range of positions, the hybrid electric powerplant is configured to:
operate an engine having a mechanical output;
output first electrical energy from a motor/generator driven by the mechanical output of the engine; and
drive a propulsion mechanism by the mechanical output of the engine; and
in a second subset of positions within the overall range of positions, the hybrid electric powerplant is configured to:
operate the engine having the mechanical output;
receive second electrical energy at the motor/generator;
drive the mechanical output with the motor/generator using the second electrical energy; and
drive the propulsion mechanism by the mechanical output.

5. A method for adjusting output of a hybrid-electric powerplant of an aircraft using the lever of claim 4.

6. A non-transitory computer readable medium having instructions stored thereon that, upon execution by a computing device, cause the computing device to perform operations for adjusting output of a hybrid-electric powerplant of an aircraft using the lever of claim 4.

7. The lever of claim 4, wherein the first subset of positions represent a first continuous group of positions.

8. The lever of claim 7, wherein the second subset of positions represent a second continuous group of positions.

9. The lever of claim 8, wherein one of the first subset of positions is adjacent to one of the second subset of positions.

10. The lever of claim 4, wherein the movement of the lever adjusts the output of the hybrid-electric powerplant between three or more modes of operation.

11. A thrust control system for adjusting output of a hybrid-electric powerplant of an aircraft comprising:
an input of a controller configured to receive commands;
the controller configured to set the mode of operation of a hybrid system based on the commands, wherein the mode of operation comprises an output mode of the hybrid-electric powerplant, and wherein there are at least two modes of operation, and further wherein:
upon receipt of a first command at the input, the hybrid electric powerplant is configured to:
operate an engine having a mechanical output;
output first electrical energy from a motor/generator driven by the mechanical output of the engine, the first electrical energy being output to an electric propulsion motor of the aircraft and a battery of the aircraft; and
upon receipt of a second command at the input, the hybrid electric powerplant is configured to:
output second electrical energy from the motor/generator, the second electrical energy being output to the electric propulsion motor of the aircraft and not the battery of the aircraft.

12. The thrust control system of claim 11, wherein the input comprises a lever configured to move in response to a force from a pilot or operator such that different positions are used as commands that correspond to different modes.

13. The thrust control system of claim 11, wherein the input comprises an electrical connection with a computerized flight control system, wherein the controller is configured to receive, from the computerized flight control system, electronic commands that correspond to different modes.

14. The thrust control system of claim 11, upon receipt of the first command the hybrid electric power plant is operated in a first mode of the at least two modes of operation, and upon receipt of the second command the hybrid electric power plant is operated in a second mode of the at least two modes of operation.

15. The thrust control system of claim 14, wherein in the second mode, the battery is configured to output third electrical energy to the electric propulsion motor of the aircraft.

16. The thrust control system of claim 14, wherein in the second mode, the motor/generator is driven by the mechanical output of the motor/generator.

17. The thrust control system of claim 11, wherein the electric propulsion motor is connected to an inverter and the inverter is connected to a direct current (DC) bus.

18. The thrust control system of claim 17, wherein the battery is connected to the DC bus.

19. The thrust control system of claim 18, wherein the inverter is a first inverter, and further wherein the motor/generator is connected to a second inverter.

20. The thrust control system of claim 19, wherein the second inverter is connected to the DC bus.
